(19) United States
(12) Patent Application Publication
(10) Pub. No.: US 2023/0213243 A1
(43) Pub. Date: Jul. 6, 2023

(54) Solar Energy Absorbing and Radiative Cooling Articles and Methods

(71) Applicant: 3M INNOVATIVE PROPERTIES COMPANY, St. Paul, MN (US)

(72) Inventors: Timothy J. Hebrink, Scandia, MN (US); Milind B. Sabade, Woodbury, MN (US)

(21) Appl. No.: 17/996,437

(22) PCT Filed: Apr. 16, 2021
(86) PCT No.: PCT/IB2021/053157

§ 371 Date: Oct. 18, 2022

Related U.S. Application Data
(60) Provisional application No. 62/704,349, filed on May 6, 2020.

(51) Int. Cl. F24S 23/70; H02S 10/30; H02S 40/22

(52) U.S. Cl. CPC F24S 23/82; H02S 10/30; H02S 40/22; F24S 10/00

(57) ABSTRACT

Passive cooling articles may include a first element defining a high absorbance in an atmospheric infrared wavelength range and a high average reflectance in a solar wavelength range. The first element may define a first major surface (114, 214, 314, 414) positioned and shaped to reflect solar energy in the solar wavelength range to an energy absorber (108, 208, 308, 408, 508, 608) spaced a distance from the first major surface (114, 214, 314, 414). The energy absorber (108, 208, 308, 408, 508, 608) may be a heating panel or a photovoltaic cell. A second element may define a high thermal conductivity and thermally coupled to a second major surface (116, 216, 416) of the first element to transfer thermal energy from the second element to the first element to cool the second element.

### SUMMARY

The present disclosure relates to solar energy absorbing and radiative cooling articles, processes, and techniques. In some embodiments, the present disclosure relates to solar absorbing and radiative cooling articles that provide the dual functionality of absorbing energy and cooling (often described as integrated or hybrid articles). In some embodiments, these articles include (1) high reflectivity elements used for reflecting solar energy to an energy absorber for solar energy conversion and (2) high emissivity elements used for cooling. In some aspects, the solar energy may be converted into heat or electrical energy. In some aspects, the present techniques are usable with heating and cooling systems, such as a heat exchanger attached to a building. Particular types of heat exchangers may include, but are not limited to, absorption chillers and steam condensers. In some aspects, the present techniques are usable with electrical energy generators, which may include photovoltaic cells. Articles may include various macrostructures, microstructures, or even nanostructures to facilitate particular properties described herein. As used herein, the term “articles” may also be described as apparatus or systems depending on the context of usage.

In some embodiments, the present disclosure relates to a passive cooling article including a first element defining a first absorbance of greater than or equal to 0.5 in an atmospheric infrared wavelength range from 8 to 13 micrometers and at least partially defining a first average reflectance of greater than or equal to 80% in a solar wavelength range from 0.4 to 2.5 micrometers. The first element includes a first major surface positioned and shaped to reflect solar energy in the solar wavelength range to an energy absorber spaced a distance from the first major surface. The passive cooling article includes a second element defining a thermal conductivity greater than 0.1 W/m-K. The second element is thermally coupled to a second major surface of the first element to transfer thermal energy from the second element to the first element to cool the second element.

In some embodiments, the first element may include a multi-layer optical film. In some embodiments, the first element may include an ultraviolet reflecting multi-layer optical film. In some embodiments, the energy absorber may include an interior volume to contain a fluid heatable by the solar energy. In some embodiments, the energy absorber may include a photovoltaic cell. In some embodiments, the first element may be a specular solar mirror in the solar wavelength range. In some embodiments, the first major surface may have a curved shape. In some embodiments, the curved shape may have a parabolic curve. In some embodiments, the curved shape may have a compound parabolic curve.

In some embodiments, the present disclosure relates to a passive cooling article including a first element having a first region of a first major surface, the first element defining a first absorbance of greater than or equal to 0.5 in an atmospheric infrared wavelength range from 8 to 13 micrometers and at least partially defining a first average reflectance of greater than or equal to 80% in the solar wavelength range. The passive cooling article includes a second element defining a thermal conductivity greater than 0.1 W/m-K. The second element is thermally coupled to a first region of a second major surface defined by the first element to transfer heat from the second element to the first element to cool the second element. The passive cooling article includes an energy absorber having a second region of the first major surface. The energy absorber is configured to receive solar energy in a solar wavelength range from 0.35 to 2.5 micrometers. The first region of the first major surface is positioned and shaped to direct reflected solar energy in the solar wavelength range to the second region.

In some embodiments, the energy absorber may include an interior volume to contain a fluid heatable using the solar energy. In some embodiments, the first region of the first major surface may have a planar shape. In some embodiments, the energy absorber may include a photovoltaic cell. In some embodiments, a first vector normal to at least a portion of the first region of the first major surface may define an element angle with a second vector normal to at least a portion of the second region of the first major surface. The element angle may be greater than or equal to 90 degrees and less than or equal to 175 degrees. In some embodiments, the first element may include a diffuse solar mirror in the solar wavelength range. In some embodiments, the diffuse solar mirror may include a microporous polymer layer or an array of inorganic particles having an effective D90 particle size of at most 50 micrometers. In some embodiments, the article may further include a plurality of the first elements and a plurality of the second elements arranged in an alternating array between a first end region and a second end region. In some embodiments, the second region of the first major surface may have a curved shape.

In some embodiments, the present disclosure relates to a passive cooling system including an energy absorber configured to receive solar energy in a solar wavelength range from 0.35 to 2.5 micrometers. The passive cooling system may include a solar mirror element defining a first absorbance of greater than or equal to 0.6 in an atmospheric infrared wavelength range from 8 to 13 micrometers and at least partially defining a first average reflectance of greater than or equal to 80% in the solar wavelength range. The solar mirror element may include a first major surface shaped to direct reflected solar energy in the solar wavelength range to the energy absorber. The passive cooling element may include a coolable element defining a thermal conductivity greater than 0.1 W/m-K. The coolable element may be thermally coupled to a second major surface of the solar mirror element to transfer heat from the coolable element to the solar mirror element to cool the coolable element.

In some embodiments, the energy absorber, the coolable element, or both may be thermally coupled to an absorption chiller subsystem. In some embodiments, the energy absorber, the coolable element, or both may be thermally coupled to a steam condenser subsystem. In some embodiments, the energy absorber may include a photovoltaic module and the coolable element may be thermally coupled to cool the photovoltaic module. In some embodiments, the photovoltaic module may be designed to absorb solar energy in the range of 0.35 to 1.6 micrometers. In some embodiments, the photovoltaic module may be designed to absorb solar energy in the range of 0.35 to 1.1 micrometers. In some embodiments, the photovoltaic module may be designed to absorb solar energy in the range of 0.35 to 0.9 micrometers.

As used herein, the term “passive cooling” refers to passive radiative cooling that may provide cooling without consuming energy from a source of energy, such as a battery or other electricity source. Passive cooling may be defined in contrast to “active cooling” for which a source of energy is consumed (for example, cooling by air conditioning unit having a compressor and fan powered by electricity).

As used herein, the term “light” refers to electromagnetic energy of any wavelength. In some embodiments, light means electromagnetic energy having a wavelength of at most 20 micrometers, or at most 13 micrometers. In some embodiments, light means radiant energy in a region of the electromagnetic spectrum from 0.25 to 20 micrometers.

As used herein, the “solar region” or “solar wavelength range” of the electromagnetic spectrum refers to a portion of the electromagnetic spectrum that partially or fully includes sunlight or solar energy. The solar region may include at least one of the visible, ultraviolet, or infrared wavelengths of light. The solar region may be defined as wavelengths in a range from 0.4 to 2.5 micrometers (or greater than or equal to 0.3, 0.35, or even 0.4 micrometers or less than or equal to 3.5, 3, or even 2.5 micrometers).

As used herein, the term “infrared,” “infrared region,” or “infrared wavelength range” refers to wavelengths of light that are greater than or equal to 0.8 micrometers and less than 1 millimeter. A “near-infrared region” refers to wavelengths from 0.8 to 4 micrometers. A “mid-infrared region” refers to wavelengths from 4 to 20 micrometers.

As used herein, the “atmospheric infrared region” or “atmospheric infrared wavelength range” of the electromagnetic spectrum refers to a portion of the electromagnetic spectrum that partially or fully includes wavelengths that can be partially transmitted through the atmosphere. The atmospheric infrared region may include the atmospheric window region, which is generally defined as wavelengths ranging from 8 to 13 micrometers, 7 to 14 micrometers, or even 6 to 14 micrometers. The atmospheric infrared region may include the mid-infrared region from 4 to 20 micrometers.

As used herein, the term “visible, “visible region,” or “visible wavelength range” refers to wavelengths from 0.4 to 0.8 micrometers.

As used herein, the term “material” refers to a monolithic material or composite material.

As used herein, the terms “transmittance” and “transmission” refer to the ratio of total transmission of a layer of a material compared to that received by the material, which may account for the effects of absorption, scattering, reflection, etc. Transmittance (T) may range from 0 to 1 or be expressed as a percentage (T %).

The term “average transmittance” refers to the arithmetic mean of a sample of transmittance measurements over a range of wavelengths.

Transmission can be measured with methods described in ASTM E1348-15e1 (2015). A Lambda 1050 spectrophotometer equipped with an integrating sphere was used to make transmission measurements described herein. The Lambda 1050 was configured to scan from 250 nanometer wavelengths of light to 2500 nanometer wavelengths of light at 5 nanometer intervals in transmission mode. Background scans are conducted with no sample in the light path before the integrating sphere, and the standard spectralon covers over the integrating sphere ports. After background scans are made, the film sample is placed in the light path by covering the entrance port to the integrating sphere with the film sample. Light transmission spectrum scans are made using the standard detectors for a range from 250 nanometers to 2500 nanometers and recorded by the software provided with the Lambda 1050.

As used herein, the term “minimum transmittance” refers to the lowest transmittance value over a range of wavelengths.

As used herein, the terms “reflectance” and “reflectivity” refer to the effectiveness in reflecting light for a surface of an object. The term “average reflectance” refers to at least one of: a measurement of the reflectance of uniformly unpolarized light (for at least one incidence angle) or the average of reflectance measurements of two or more polarizations of light (for example, s and p polarizations, for at least one angle of incidence).

Reflection can be measured with methods described in ASTM E1349-06 (2015). A Lambda 1050 spectrophotometer equipped with an integrating sphere was used to make reflection measurements described herein. The Lambda 1050 was configured to scan from 250 nanometers to 2500 nanometers at 5 nanometer intervals in reflection mode. Background scans are conducted with no sample in the light path and spectralon standards covering the integrating sphere ports. After background scans are made, the spectralon standard at the back of the integrating sphere is replaced with the film sample. Light reflection spectrum scans are made using the standard detectors for a range from 250 nanometers to 2500 nanometers and recorded by the software provided with the Lambda 1050. Solar reflectivity can be reported as a weighted average over the solar wavelength range. In some embodiments, any of the above-listed values may be an average value obtained by weighting the results over the wavelength range, according to the weightings of the AM1.5 standard solar spectrum.

As used herein, “emissivity” of a surface of a material is its effectiveness in emitting energy as thermal radiation. The emissivity may be described as a ratio of the radiant exitance of the surface compared to that of a black body at the same temperature as the surface and can range from 0 to 1. Emissivity can be measured using infrared imaging radiometers with methods described in ASTM E1933-99a (2010).

As used herein, the term “absorbance” refers to the base 10 logarithm of a ratio of incident radiant power to transmitted radiant power through a material. The ratio may be described as the radiant flux received by the material divided by the radiant flux transmitted by the material. Absorbance (A) may be calculated based on transmittance (T) according to Eq. 1:

A=−log₁₀ T=2−log₁₀ T% (Equation 1)

As used herein, the term “absorptivity” of a surface of a material is its effectiveness in absorbing radiant energy. The absorptivity may be described as a ratio of the radiant flux absorbed by the surfaced compared to that received by the surface. As known to those of ordinary skill in the art, emissivity is equal to the absorptivity of the surface of the material. In other words, a high absorbance means high emissivity, and a low absorbance means low emissivity. Therefore, emissivity and absorptivity may be used interchangeably throughout this disclosure to describe this property of the material.

Absorbance in the solar region can be measured with methods described in ASTM E903-12 (2012). Absorbance measurements described herein were made by making transmission measurements as previously described and then calculating absorbance using Equation 1.

As used herein, the term “minimum absorbance” refers to the lowest absorbance value over a range of wavelengths.

As used herein, the term “average absorbance” refers to the arithmetic mean of a sample of absorbance measurements over a range of wavelengths. For example, absorbance measurements in a range from 8 to 13 micrometers can be averaged over that range.

As used herein, the term “high absorbance” refers to an absorbance greater than or equal to 0.5 (in some embodiments, greater than or equal to 0.6, 0.7, 0.8, 0.9, 1, 1.5, 2, 2.5, 3, 3.5, 4, 4.5, or even 5).

As used herein, the term “high reflectance” refers to a reflectance greater than or equal to 60% (in some embodiments, greater than or equal to 70, 80, 85, 90, 91, 92, 93, 94, 95, 96, 97, 98, 99, or even 99.5%). Accordingly, the term “high average reflectance” refers to an average reflectance across a particular wavelength band being greater than or equal to 60% (in some embodiments, greater than or equal to 70, 80, 85, 90, 91, 92, 93, 94, 95, 96, 97, 98, 99, or even 99.5%).

As used herein, the term “thermal conductivity” is a material property that refers to the rate at which heat passes through the material or the amount of heat that flows per unit time (watt) through a material with a temperature gradient of one degree (K) per unit distance (meter).

As used herein, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries. Polymers also include synthetic and natural organic polymers (for example, cellulose polysaccharides and their derivatives).

As used herein, the term “fluoropolymer” refers to any polymer having fluorine. In some embodiments, a fluoropolymer may be described as a fluoroplastic or, more particularly, a fluorothermoplastic (for example, fluorothermoplastics available under the trade designation “3M DYNEON THV” from the 3M Company of St. Paul, Minn.).

In reference to the antisoiling layer, the term or prefix “micro” refers to at least one dimension defining a structure or shape being in a range from 1 micrometer to 1 millimeter. For example, a microstructure may have a height or a width that is in a range from 1 micrometer to 1 millimeter.

As used herein, the term or prefix “nano” refers to at least one dimension (or all dimensions) that define a structure or a shape being less than 1 micrometer. For example, a nanostructure may have at least one of a height or a width (or both) that is less than 1 micrometer.

As used herein, the term “microporous” refers to having internal porosity (continuous or discontinuous) having average pore diameters of 50 to 10,000 nanometers.

As used herein, the term “micro-voided” refers to having internal discrete voids having an average void diameter of 50 to 10,000 nanometers.

As used herein, the term “maximum diameter” refers to a longest dimension based on a straight line passing through an element having any shape.

As used herein, the term “average slope” refers to an average slope throughout a particular portion of a line.

As used herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (for example, comprise and derivatives thereof) are considered to additionally be recited in closed-ended language (for example, consist and derivatives thereof) and in partially closed-ended language (for example, consist essentially, and derivatives thereof).

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

As used herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “at least,” “at most,” and “up to” a number (for example, up to 50) includes the number (for example, 50).

As used herein, the recitations of numerical ranges by endpoints include all numbers subsumed within that range as well as the endpoints (for example, 1 to 5 includes 1, 1.5, 2, 2.75, 3, 3.80, 4, 5, etc.).

The terms “in the range,” “ranging from,” and “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that at least one member of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in at least one embodiment.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a schematic illustration of one example of a system including a solar energy absorbing and radiating cooling article according to the present disclosure.

FIG. 2 is a schematic cross-sectional illustration of one example of a configuration of the article of FIG. 1 using a parabolic shape.

FIG. 3 is a schematic cross-sectional illustration of another example of a configuration of the article FIG. 1 using a compound parabolic shape.

FIG. 4 is a schematic cross-sectional illustration of yet another example of a configuration for the article 102 of FIG. 1 using a planar shape.

FIG. 5 is a schematic illustration of one example of a configuration for the system of FIG. 1 including an absorption chiller subsystem.

FIG. 6 is a schematic illustration of another example of a configuration for the system of FIG. 1 including a steam condenser subsystem.

FIG. 7 is a graph of an energy spectrum of solar energy (or sunlight) described as terrestrial reference spectrum found in ASTM G173-03 (2012), an energy transmission % spectrum in an atmospheric window region, and one example of an absorption of high emissivity elements of a passive cooling article usable with the system of FIG. 1.

FIG. 8 is a schematic illustration of one example of a high emissivity element that includes a multilayer optical film usable with the system of FIG. 1.

FIG. 9 is a schematic top-down illustration of one example of a surface having a plurality of structures usable with the system of FIG. 1.

FIGS. 10-13 are schematic illustrations of various examples of surface structures usable with the system of FIG. 1.

FIGS. 14A, 14B, and 14C are schematic perspective and cross-sectional illustrations of one example of an antisoiling surface structure usable with the system of FIG. 1.

FIG. 15 is a schematic cross-sectional illustration of another example of an antisoiling surface usable with the system of FIG. 1.

FIG. 16 is a schematic cross-sectional illustration of yet another example of an antisoiling surface usable with the system of FIG. 1.

FIGS. 17A-B are schematic cross-sectional illustrations of various examples of surface structures usable with the system of FIG. 1.

FIG. 18 is a schematic perspective illustration of one example of a further antisoiling surface usable with the system of FIG. 1.

FIG. 19 is a schematic top-down of still another antisoiling surface usable with the system of FIG. 1.

FIGS. 20 and 21 are schematic perspective illustrations of yet another antisoiling surface usable with the system of FIG. 1.

### DETAILED DESCRIPTION

The present disclosure relates to solar energy absorbing and radiative cooling articles, processes, and techniques. In particular, the present disclosure relates to solar absorbing and radiative cooling articles that provide the dual functionality of absorbing energy and cooling. These articles and systems can be described as integrated or hybrid articles, wherein high reflectivity elements are used for (1) reflecting solar energy to an energy absorber for solar energy conversion and (2) high emissivity elements are used for cooling. In some aspects, the solar energy may be converted into heat or electrical energy. In some aspects, the present techniques are usable with heating and cooling systems, such as a heat exchanger attached to a building Particular types of heat exchangers may include, but are not limited to, absorption chillers and steam condensers. In some aspects, the present techniques are usable with electrical energy generators, which may include photovoltaic cells. Articles may include various macrostructures, microstructures, or even nanostructures to facilitate particular properties described herein. As used herein, the term “articles” may also be described as apparatus or systems depending on the context of usage.

Significant amounts of energy can be absorbed by objects exposed to sunlight and, in many situations, significant amounts of energy are consumed to cool such objects, such as buildings, supermarket refrigerators, data centers, power generators, and transportation vehicles (such as cars, trucks, trains, buses, ships, airplanes, etc.). Using passive radiative cooling to cool these objects warmed by the sun is appealing because it provides cooling with no external energy sources, thereby reducing cost and providing a more sustainable cooling mechanism. Use of passive cooling may reduce the overall energy required to maintain a suitable temperature, which may significantly reduce operational costs and reduce greenhouse gas emissions, especially in vehicular applications where fossil fuels may be used to provide air conditioning or refrigeration. Further, passive cooling may reduce the overall demand for water, for example, in thermoelectric generation that would otherwise use cooling towers and spray ponds to evaporate water for cooling.

The present disclosure provides passive cooling articles capable of providing cooling during the day and night. For example, the passing cooling articles described herein may be used to cool the walls, roofs, etc. of buildings (e.g., supermarkets, data storage centers, etc.) or transportation vehicles (e.g., semi-truck trailers, etc.)).

In general, surface material properties for passive radiative cooling to occur during the day include low emittance over the solar energy wavelengths of 0.3 to 2.5 micrometers and high emittance over infrared wavelength range of 3 to 20 microns. For cooling surfaces below air temperature by passive radiative cooling, the surface may have high emittance in the infrared wavelength range of 8 to 13 micrometers and not in the wavelength range of 3 to 8 micrometers (or 13 to 20 micrometers). According to Kirchoff's law of thermal radiation, high emittance correlates to high absorbance.

In some aspects, the solar energy absorbing and radiative cooling articles described herein may be used as, and described as, a heating and cooling article. Articles of the present disclosure may include one or more layers of material to provide reflectance in the solar region and high absorption/emissivity in the atmospheric infrared region. Reflectance in the solar region may be particularly effective in redirecting solar energy to an energy absorber, which may also be described as a solar energy absorber or solar energy collector. Reflectance in the solar region may also be particularly effective in facilitating cooling during the day when subjected to sunlight by reflecting sunlight that would otherwise be absorbed by the object. In particular, the article may be positioned to reflect solar energy away from a cooling element. Absorption in the atmospheric infrared region may be particularly effective in facilitating cooling at night by radiating or emitting infrared light. Energy may also be radiated or emitted during the day to some degree. In general, the high emissivity element may be configured to absorb a minimum of solar energy from 0.4 to 2.5 micrometers and radiate a maximum of energy from 8 to 13 micrometers (for example, by maximizing absorbance and thus emissivity), especially when cooling the cooling element to a temperature below air temperature. In some embodiments, when cooling the cooling element to a temperature above, or equal to, air temperature, the high emissivity element may be configured to absorb a minimum of solar energy from 0.4 to 2.5 micrometers and radiate a maximum of energy from 4 to 20 micrometers. The energy absorber and the cooling element may be operably coupled to one another as part of a heat exchanger, which may also be described as a heat exchanging system.

In some embodiments, the heating and cooling articles described herein may include a composite cooling film and exhibit relatively broadband absorption (and thus emission). The use of a cooling film that exhibits broadband emission may advantageously enhance the ability of the cooling film to passively cool an entity that, in normal operation, is often at a temperature above (in some embodiments, significantly above), the ambient temperature of the surrounding environment. Such entities may include, for example, a heat-rejecting unit (such as a portion of a heat exchanger, condenser, or compressor, and any associated items) of a cooling, refrigeration, or heat pump system. Such a heat-rejecting entity may be, for example, an external (or outdoor) unit of a residential cooling or a heating ventilation air conditioning (HVAC) system or of a commercial or large-scale cooling or HVAC system. In some cases, such a heat-rejecting entity may be an external unit of a commercial refrigeration or freezer system. Various examples of heat-rejecting entities, which may also benefit from dual functionality including heating, include absorption chillers and steam condensers. In some embodiments, various heat-rejecting entities include an external component of a cooling unit of a large refrigerated shipping container such as a truck trailer, rail car, or intermodal container. (Such large-scale refrigerated shipping containers and the like may be referred to as “reefers” in the trade.) In some embodiments, such an entity may be a high-voltage transformer, or a high-powered broadcast antenna (such as used in mass-element or beam-forming systems for 5G wireless communication).

The articles described may reflect light in a solar region of the electromagnetic spectrum toward an energy absorber and to radiate light in an atmospheric infrared region of the electromagnetic spectrum toward the sky to cool a coolable element. The articles described herein may include, or be described as, high emissivity solar mirrors or broadband solar mirrors. The mirrors may have specular reflectivity or diffuse reflectivity. The opposing mirror surfaces may be additionally textured, for example, to provide drag reduction or antisoiling properties.

In some aspects, hybrid solar thermal heating and cooling articles are capable of heating one fluid while simultaneously cooling another fluid. Broadband solar mirror films may be used to concentrate solar energy onto solar energy absorbing tubes or other solar energy absorbing articles containing a fluid to be heated. Thermally coupled to the back side of the broadband solar mirror film may be additional tubes or containers of fluids which will be cooled by radiative cooling to the relatively colder sky. In some aspects, a broadband solar mirror film also be described as, or include, an ultraviolet (UV) solar mirror, wherein the UV spectrum is reflected.

This integrated articles described herein may be connected to energy systems that use both heating for steam generating and cooling for condensing the steam. These hybrid solar thermal heating and radiative cooling systems are also useful for climates where heating is required in the winter and cooling is required in the summer.

In some aspects, the articles described herein are capable of heating one fluid while simultaneously cooling another fluid. Broadband solar mirror films are used to concentrate solar energy onto solar energy absorbing tubes or other solar energy absorbing articles containing a fluid to be heated using external compound parabolic concentrator (XCPC) configuration. Solar thermal collectors, or solar heating panels, may be oriented toward a southern direction when located in the northern hemisphere, or vice versa for the southern hemisphere. The article can be integrated with radiative cooling panels that are facing north in the northern hemisphere, or vice versa for the southern hemisphere. Both types of panels may benefit from being tilted in opposite (or opposing) directions.

In some aspects, solar thermal heating panels may be replaced with photovoltaic panels, or cells, having heat transfer channels on their back side that are fluidly coupled to heat transfer channels on the back side of the passive radiative cooling panels.

Although reference is made herein to certain applications, such as buildings and vehicles, the heating and cooling articles may be used in any outdoor environment to provide heating and cooling to a structure or substrate, particularly when exposed to solar energy from sunlight. Non-limiting examples of applications of the passive cooling article include absorption chillers, steam condensers, commercial building air conditioning, commercial refrigeration (for example, supermarket refrigerators), data center cooling, heat transfer fluid systems, power generator cooling, vehicle air conditioning or refrigeration (for example, cars, trucks, trains, buses, ships, airplanes, etc.), electrical transformers, or communication antennas. In particular, the passive cooling articles may be applied to the generally vertical sides of refrigerated semi-truck trailers or buses, which may facilitate cooling. In particular, the passive cooling article cools a fluid (which may be a liquid or gas) which is then used to remove heat from a cooling system (such as refrigeration or air conditioning) via a heat exchanger. Various other applications will become apparent to one of skill in the art having the benefit of the present disclosure.

Reference will now be made to the drawings, which depict at least one feature described in this disclosure. However, it will be understood that other features not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar.

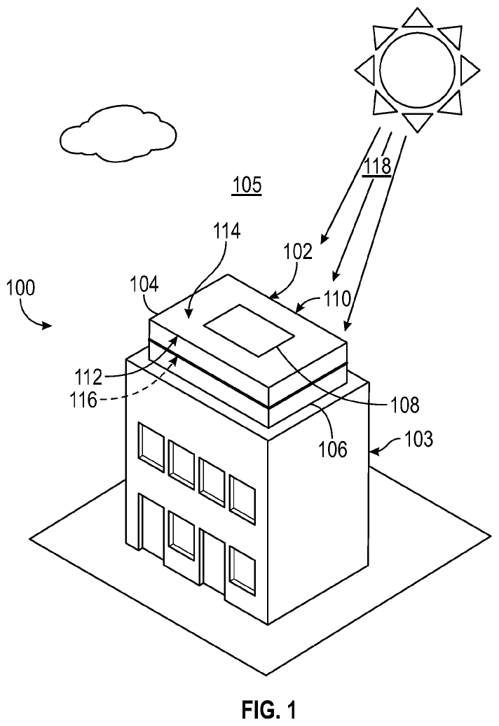

FIG. 1 is a schematic illustration of one example application of a system 100, which may also be described as a solar energy absorbing and passive cooling system in some cases. The system 100 may include an article 102 coupled to a surface of a substrate 103, which is illustrated as a stationary building. In general, the article 102 may be disposed or applied to an exterior surface of the substrate 103, particularly an exterior surface exposed to solar energy 118 from the sun (for example, an outer wall or side surface). In some embodiments, the article 102 may be thermally coupled to the substrate 103, which may allow for heat transfer therebetween. The article 102 may be suitable for outdoor environments and have, for example, a suitable operating temperature range, water resistance, dirt resistance, and ultraviolet (UV) stability.

In general, the solar mirror element 104 defines a first major surface 114 positioned and shaped to reflect the solar energy 118 in the solar wavelength range to energy absorber 108 spaced a distance from the first major surface 114. The first major surface 114 may be defined by the article 102 opposite to a second major surface 116 positioned closer to the substrate 103. In some embodiments, the second major surface 116 of the article 102 may be coupled to the substrate 103. For example, the second major surface 116 of the article 102 may be bonded or adhered to the substrate 103.

The article 102 may be mechanically supported by the substrate 103. In some aspects, the article 102 is not substantially thermally coupled to the substrate 103. In particular, the coupling between the article 102 and the substrate 103 may be configured to not substantially affect the thermal operation of the system 100 to absorb solar energy or provide passive cooling.

Any suitable type of solar mirror element 104 may be used. In some aspects, the solar mirror element 104 may include a specular solar mirror. In other aspects, the solar mirror element 104 may include a diffuse solar mirror.

The solar mirror element 104 may define a first absorbance of greater than or equal to 0.5. In some aspects, the first absorbance may be greater than or equal to 0.6, 0.7, 0.8, 0.9, 0.95, or even up to 1 in the atmospheric infrared wavelength range. In some aspects, the atmospheric infrared wavelength range may include the mid-infrared region from 4 to 20 micrometers, which may facilitate cooling to ambient or above ambient air temperatures. In some aspects, the atmospheric infrared wavelength range may include, or be limited to, 8 to 13 micrometers, which may facilitate cooling to sub ambient air temperatures. In some aspects, the atmospheric infrared wavelength range may be defined from 4 to 20 micrometers.

Among other parameters, the amount of cooling and temperature reduction may depend on the reflective and absorptive properties of the article 102. In some aspects, high emissivity in the atmospheric window region may facilitate cooling below ambient air temperatures. The cooling effect of the article 102 may be described with reference to a first temperature of the ambient air proximate or adjacent to the substrate and a second temperature of the portion of the substrate 103 proximate or adjacent to the article 102. In some embodiments, the first temperature is greater than the second temperature by at least 2.7 (in some embodiments, at least 5.5, 8.3, or even at least 11.1) degrees Celsius (for example, at least 5, 10, 15, or even at least 20 degrees Fahrenheit).

The solar mirror element 104 may also define a first average reflectance of greater than or equal to 80%. In some aspects, the first reflectance may be greater than or equal to 90% in a solar wavelength range from 0.4 to 2.5 micrometers. In some aspects, the solar wavelength range may be defined 0.3 or 0.35 to 3.5 or 3 micrometers.

The article 102 may define a first end region 110 and a second end region 112. The first end region 110 and the second end region 112 may be proximate, or adjacent to, on opposite ends of the article 102. In some aspects, the article 102, when applied, may be oriented such that the first end region 110 is on average closer to the source of solar energy 118 (for example, facing south when located in the northern hemisphere) and the second end region 112 is on average further from the source of solar energy 118 (for example, facing north when located in the northern hemisphere).

The first major surface 114 defined by the solar mirror element 104 may include any suitable shape or combination of shapes to reflect at least some of the solar energy 118 to the energy absorber 108. In some aspects, first major surface 114 may include one or more curved shapes. The curved shape may be defined in at least a cross-section, for example, to include a parabolic curve or a compound parabolic curve. The three-dimensional curved shape may be described as a parabolic trough or a compound parabolic trough, respectively. The system 100 may be described as including a parabolic concentrator or a compound parabolic concentrator geometry, respectively. Further, the first major surface 114 may be appropriately positioned such that the energy absorber 108 resides proximate to, or at, the focus of the shape formed by the first major surface 114.

When using a curved shape, the solar mirror element 104 may be configured to provide a specular mirror or specular reflectivity. The curved shape may also be used when the energy absorber 108 includes a solar thermal collector, which may facilitate higher concentrations of the solar energy 118 onto the energy absorber 108 (for example, greater than 10 times the concentration of the solar energy), for example, compared to a planar shape. The curved shape may be used when the energy absorber 108 is designed to reach a high range of temperatures (for example, above 200 degrees Celsius).

A non-limiting example of a parabolic shape made using a polymeric solar mirror film, for example, as a solar mirror element 104, is described in U.S. Pat. No. 9,523,516 (Hebrink et al.), issued Dec. 20, 2016, which is incorporated by reference. A coolable element 106 thermally coupled to a heat exchanger may be applied to the backside of such a polymeric solar mirror film enable cooling of a fluid by radiative cooling heat transfer from the polymeric solar mirror film to cooler temperatures in the sky.

A non-limiting example of a compound parabolic shape made using a polymeric solar mirror film, for example, as solar mirror element 104, is described in U.S. Pat. No. 9,383,120 (Hebrink et al.), issued Aug. 5, 2016, which is incorporated by reference. A coolable element 106 thermally coupled to a heat exchanger on the backside to enable cooling of a fluid by radiative cooling heat transfer from the polymeric solar mirror film to cooler temperatures in the sky.

In some aspects, the first major surface 114 may include a substantially planar shape. In some aspects, the article 102 may include a plurality of more than one solar mirror element 104 and a plurality of more than one coolable element 106. The plurality of elements may be arranged in an alternating array, which alternates between one solar mirror element 104 and one coolable element 106, between the first end region 110 and the second end region 112.

When using a planar shape, the solar mirror element 104 may be configured to provide a diffuse mirror or diffuse reflectivity. The diffuse mirror, which may be used with a planar or curved shape, may be used when the energy absorber 108 includes a photovoltaic cell, which may facilitate a more uniform solar flux onto the photovoltaic cell and a multiplied concentration of the solar energy 118 (for example, 2 to 3 times the concentration of solar energy). The planar shape may also be used when the energy absorber 108 is designed to only achieve a lower range of temperatures than, for example, the range of temperatures achievable when using a curved shape, such as a parabola or compound parabola.

Any suitable type of coolable element 106 may be used. In some aspects, the coolable element 106 may include a thermally conductive material, such as metal. A non-limiting example of a metal is aluminum. The coolable element 106 may also define an interior volume, which may be part of a fluid cooling loop. In some aspects, the coolable element 106 may be a thermally conductive material having a thermal conductivity greater than or equal to 0.1 W/m-K (in some embodiments, greater than or equal to 0.5 W/m-K, 1.0 W/m-K, or even 5.0 W/m-K),

The coolable element 106 may be thermally coupled to a second major surface 116 of the solar mirror element 104 to transfer thermal energy, or heat, from the coolable element 106 to the solar mirror element 104 to cool the coolable element 106.

Any suitable type of energy absorber 108 may be used. In some aspects, the energy absorber 108 may be configured to generate heat in response to absorbing the solar energy 118 at least in the solar wavelength range reflected by the solar mirror element 104. The received solar energy 118 may be used by the system 100 for particular heating processes. For example, the energy absorber 108 may define an interior volume to contain a fluid heatable using the solar energy 118. In some aspects, the energy absorber 108 may be configured to generate electrical energy in response to absorbing the solar energy 118, which may be used by the system 100 to provide electrical energy for particular processes. For example, the energy absorber 108 may include one or more photovoltaic cells to convert solar energy to electrical energy.

The energy absorber 108 absorb solar energy in particular wavelengths for heating or generating electrical energy. In some aspects, for example, when the energy absorber 108 is designed to generate electrical energy with photovoltaic cells, each energy absorber 108 may absorb solar energy greater than or equal to 0.35, 0.4, or even 0.45 micrometers. In some aspects, each energy absorber 108 may absorb solar energy less than or equal to 1.6, 1.1, 0.9, or even 0.8 micrometers.

The article 102 may reflect the solar energy 118 in the solar region of the electromagnetic spectrum to cool the substrate 103, which may be particularly effective in a daytime environment. Without the article 102, the solar energy 118 may have otherwise been absorbed by the substrate 103 and converted into heat.

The article 102 may radiate light in the atmospheric infrared region of the electromagnetic spectrum into atmosphere through the sky 105 to cool the substrate 103, which may be particularly effective in a nighttime environment. The article 102 may allow heat to be converted into solar energy 118 (for example, infrared light) capable of partially transmitting through the sky 105 through the atmospheric infrared region. The radiation of solar energy 118 may be a property of the article 102 that does not require additional energy and may be described as passive radiation, which may cool the article and the substrate 103, when thermally coupled to the article 102. During the day, the reflective properties allow the article 102 to emit more energy than is absorbed. The radiative properties in combination with the reflective properties, to reflect sunlight during the day, the article 102 may provide more cooling than an article that only radiates energy through the atmosphere.

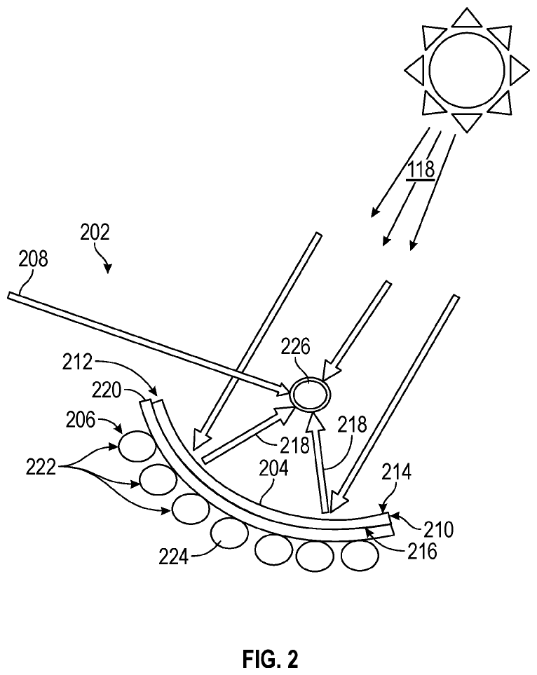

FIG. 2 is a schematic cross-sectional illustration of one example of a configuration of the article 102 of FIG. 1. As illustrated, an article 202 may include one or more of a solar mirror element 204, a coolable element 206, and an energy absorber 208, which may be used as the solar mirror element 104, the coolable element 106, and the energy absorber 108 of the article 102, respectively. The article 202 may extend from a first end region 210 to a second end region 212, which may correspond to the first end region 110 and the second end region 112 of the article 102, respectively. The article 202 may define a first major surface 214 and a second major surface 216, which may correspond to the first major surface 114 and the second major surface 116 of the article 102, respectively.

The first major surface 214 reflects solar energy 118 toward the energy absorber 208 shown as reflected solar energy 218. The first major surface 214 defines a parabolic shape. The article 202 may define an acceptance angle. The first major surface 214 may be positioned and shaped to direct solar energy 118 within the acceptance angle toward the energy absorber 208.

The coolable element 206 is configured to transfer heat to the solar mirror element 204. The coolable element 206 may include one or more of a heat spreading element 220 and a heat transport element 222. The heat transport element 222 of the coolable element 206 may define an interior volume 224. The interior volume 224 may be configured to at least partially contain a suitable thermal transfer fluid, such as water.

The energy absorber 208 may define an interior volume 226. The interior volume 226 may be configured to at least partially contain a suitable thermal transfer fluid, such as water or oil.

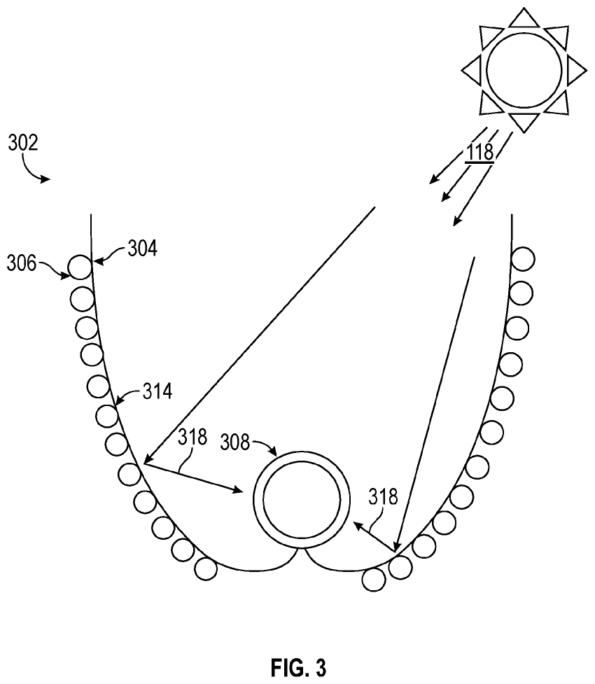

FIG. 3 is a schematic cross-sectional illustration of another example of a configuration of the article 102 of FIG. 1. As illustrated, an article 302 may include one or more of a solar mirror element 304, a coolable element 306, and an energy absorber 308, which may be used as the solar mirror element 104, the coolable element 106, and the energy absorber 108 of the article 102, respectively. The article 302 may define a first major surface 314, which may correspond to the first major surface 114 of the article 102. The article 302 may incorporate various aspects described with regard to the article 202 of FIG. 2, which are not specifically numbered or discussed with regard to the article 302. In some aspects, the article 302 may be the same as the article 202 except for the shape of the first major surface 314 defined by the solar mirror element 304. The compound parabolic shape may result in a greater range of angles of solar energy acceptance than a simple parabolic shape (see FIG. 2).

The first major surface 314 reflects solar energy 118 toward the energy absorber 308 shown as reflected solar energy 318. The first major surface 314 defines a compound parabolic shape. The article 302 may define an acceptance angle. The first major surface 314 may be positioned and shaped to direct solar energy 118 within the acceptance angle toward the energy absorber 308.

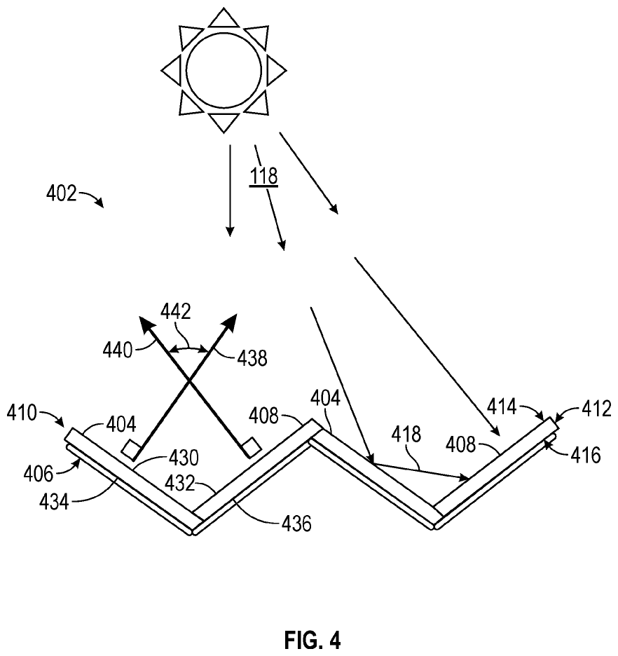

FIG. 4 is a schematic cross-sectional illustration of yet another example of a configuration for the article 102 of FIG. 1. As illustrated, an article 402 may include one or more of a solar mirror element 404, a coolable element 406, and an energy absorber 408, which may be used as the solar mirror element 104, the coolable element 106, and the energy absorber 108 of the article 102, respectively. The article 402 may extend from a first end region 410 to a second end region 412, which may correspond to the first end region 110 and the second end region 112 of the article 102, respectively. The article 402 may define a first major surface 414 and a second major surface 416, which may correspond to the first major surface 114 and the second major surface 116 of the article 102, respectively.

The first major surface 414 may include various regions defined by different elements. In some aspects, the first major surface 414 may be defined by both the solar mirror element 404 and the energy absorber 408. The first major surface 414 may extend from the first end region 410 to the second end region 412. In some aspects, the solar mirror element 404 defines a first region 430 of the first major surface 414 of the article 402. In some aspects, the energy absorber 408 defines a second region 432 of the first major surface 414 of the article 402.

As illustrated, the first region 430 includes a planar shape visible as a linear cross-sectional profile. The second region 432 also includes a planar shape visible as a linear cross-sectional profile. In some aspects, the planar shape for one or both of the first region 430 and the second region 432 may facilitate efficient energy collection by a photovoltaic cell of the energy absorber 408. Also, as illustrated, a plurality of more than one solar mirror element 404 and more than one energy absorber 408 are arranged into an array between the first end region 410 and the second end region 412.

The second major surface 416 may also include various regions defined by different elements. In some aspects, the solar mirror element 404 defines a first region 434 of the second major surface 416. In some aspects, the energy absorber 408 defines a second region 436 of the second major surface 416.

The solar mirror element 404 reflects solar energy 118 toward the energy absorber 408. In particular, the first region 430 of the first major surface 414 defined by the solar mirror element 404 may reflect solar energy 118 toward the second region 432 of the first major surface 414 defined by the energy absorber 408 shown as reflected solar energy 418. The article 402 may define an acceptance angle, or ranges of acceptance angles, that optimizes solar energy reflectance from the first region 430 of the solar mirror element 404 to the second region 432 of the solar energy absorber 408 for a given latitude. The first region 430 of the first major surface 414 may be positioned and shaped to direct solar energy 118 within a particular acceptance angle toward the second region 432 of the energy absorber 408.

The first region 430 and the second region 432 may be angled toward one another so facilitate receiving the reflected solar energy 418 at the second region 432. In some aspects, a first vector 438 normal to at least a portion of the first region 430 is conceptually defined. A second vector 440 normal to at least a portion of the second region 432 is conceptually defined. An element angle 442 may be defined between the first vector 438 and the second vector 440. In some aspects, the element angle 442 may be greater than or equal to 90 degrees. In some aspects, the element angle 442 may be defined less than or equal to 175 degrees. In some aspects, the element angle 442 may be defined greater than or equal to 100 degrees, less than or equal to 160 degrees, or both. In some embodiments, the first vector 438 and the second vector 440 may be defined normal to an average, median, or central surface orientation of the respective first region 430 or second region 432, particularly when the region is curved.

The coolable element 406 may be thermally coupled to the second major surface 416. In some aspects, the coolable element 406 is thermally coupled to the first region 434 of the second major surface 416. The coolable element 406 may be thermally coupled to only the first region 434 in some applications to facilitate receiving heat that may be generated by the energy absorber 408. In some aspects, the coolable element 406 is thermally coupled to the second region 436 of the second major surface 416. The coolable element 406 may be thermally coupled to both the first region 434 and the second region 436 when the energy absorber 408 includes a photovoltaic cell, which may facilitate cooling of the photovoltaic cell.

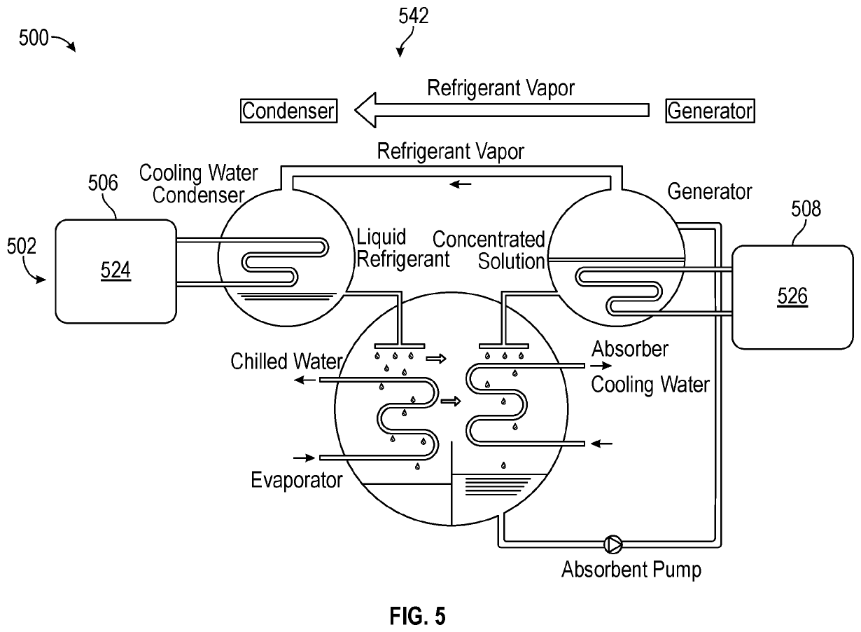

FIG. 5 is a schematic illustration of one example of a configuration for the system 100 of FIG. 1. As illustrated, the system 500 includes an article 502 and an absorption chiller subsystem 542. The article 502 of the system 500 may use any suitable configuration of the article 102 described herein.

A coolable element 506 of the article 502 may define an interior volume 524, which may be used for cooling. The interior volume 524 may be thermally coupled to a condenser of the absorption chiller subsystem 542. In particular, the interior volume 524 may be in fluid communication with a chilled fluid loop that extends into a condensation chamber to provide cooling for the absorption chiller subsystem 542.

An energy absorber 508 of the article 502 may define an interior volume 526, which may be used for heating. The interior volume 526 may be thermally coupled to a vapor generator of the absorption chiller subsystem 542. In particular, the interior volume 526 may be in fluid communication with a vapor fluid loop that includes a vapor generation chamber to provide heated vapor for the absorption chiller subsystem 542. The vapor fluid loop may extend into the condensation chamber to condense vapor in the vapor fluid loop using the chilled fluid loop.

Any suitable type of absorption chiller subsystem 542 may be selected for use in the system 500 known to one skilled in the art having the benefit of the present disclosure. In one aspect, the absorption chiller subsystem 542 may use water as a refrigerant and lithium bromide (LiBr) solution as an absorbent.

The process of cooling may go through stages such as evaporation of refrigerant in the evaporator, absorption of refrigerant by concentrated LiBr solution in an absorber, boiling of diluted LiBr solution to generate refrigerant vapor in a vapor generator, and condensation of refrigerant vapor in a condenser.

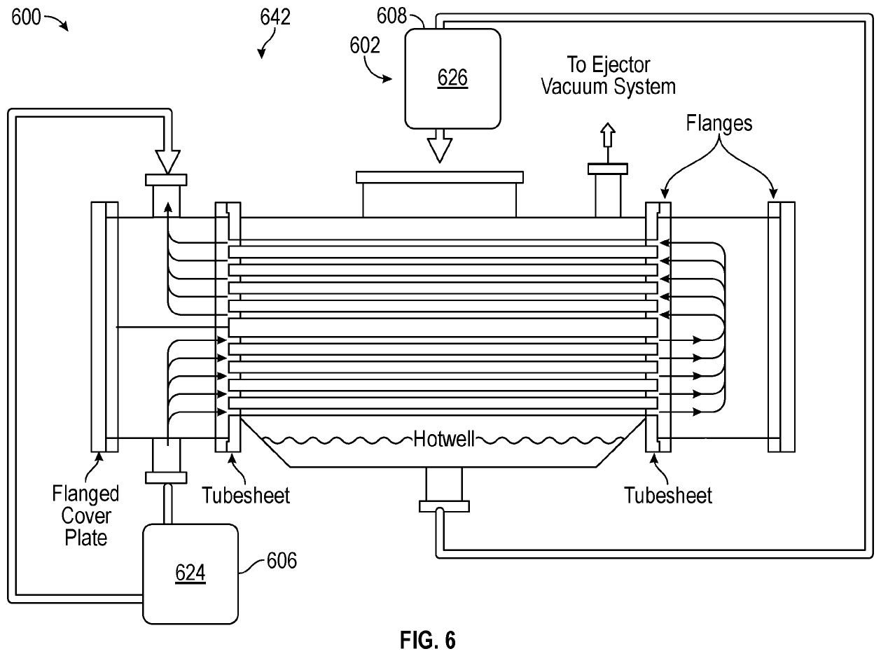

FIG. 6 is a schematic illustration of another example of a configuration for the system 100 of FIG. 1. As illustrated, the system 600 includes an article 602 and a steam condenser subsystem 642. The article 602 of the system 600 may use any suitable configuration of the article 102 described herein.

A coolable element 606 of the article 602 may define an interior volume 624, which may be used for cooling. The interior volume 624 may be thermally coupled to a condenser of the steam condenser subsystem 642. In particular, the interior volume 624 may be in fluid communication with a chilled fluid loop that extends into a condensation chamber to provide cooling for the steam condenser subsystem 642.

An energy absorber 608 of the article 602 may define an interior volume 626, which may be used for heating. The interior volume 626 may be thermally coupled to a steam generator of the steam condenser subsystem 642. In particular, the interior volume 626 may be in fluid communication with a steam-power fluid loop that includes a steam-powered element (such as a steam turbine) to provide steam energy for the steam condenser subsystem 642. The steam-power fluid loop may extend into the condensation chamber to condense steam in the steam-power fluid loop using the chilled fluid loop.

Any suitable type of steam condenser subsystem 642 may be selected for use in the system 600 known to one skilled in the art having the benefit of the present disclosure. In one aspect, the steam condenser subsystem 642 may be a water-cooled shell and tube heat exchanger, which may be used to condense exhaust steam from a steam turbine in a thermal power station. The condenser is a heat exchanger that converts steam from its gaseous to liquid state at a pressure below atmospheric pressure. Creating a low back pressure, or vacuum, at the turbine exhaust may improve conversion of high-pressure steam to mechanical power.

The solar mirror element 104 may at least partially or entirely contributes to the high average reflectance in the solar wavelength range. In some aspects, the coolable element 106 may at least partially or entirely contribute to the high average reflectance in the solar wavelength range. In some aspects, the solar mirror element 104 at least partially or entirely contributes to the high absorbance in the atmospheric wavelength range. The plurality of solar mirror element 104 may also define a high average reflectance, especially in the solar region.

In general, various suitable materials and structures may be used to at least partially (or entirely) form at least some (or all) the solar mirror element 104. Non-limiting examples of materials and structures that may be used to form the solar mirror element 104 include: a dense fluoropolymer layer, a microporous (or micro-voided) fluoropolymer layer, a dense polyester layer at least partially (or entirely) covered by a dense fluoropolymer layer, a microporous (or micro-voided) polyester layer at least partially (or entirely) covered by a dense fluoropolymer layer, a microporous (or micro-voided) polyester layer at least partially (or entirely) covered by a microporous (or micro-voided) fluoropolymer layer, a multilayer optical film at least partially (or entirely) defining a high average reflectance in the solar wavelength range, and a metal layer at least partially (or entirely) defining a high average reflectance in the solar wavelength range.

In some embodiments, at least some (or all) of the plurality of solar mirror element 104 may include inorganic particles at least partially (or entirely) defining a high average reflectance in the solar region. In particular, the inorganic particles may be, or include, white inorganic particles.

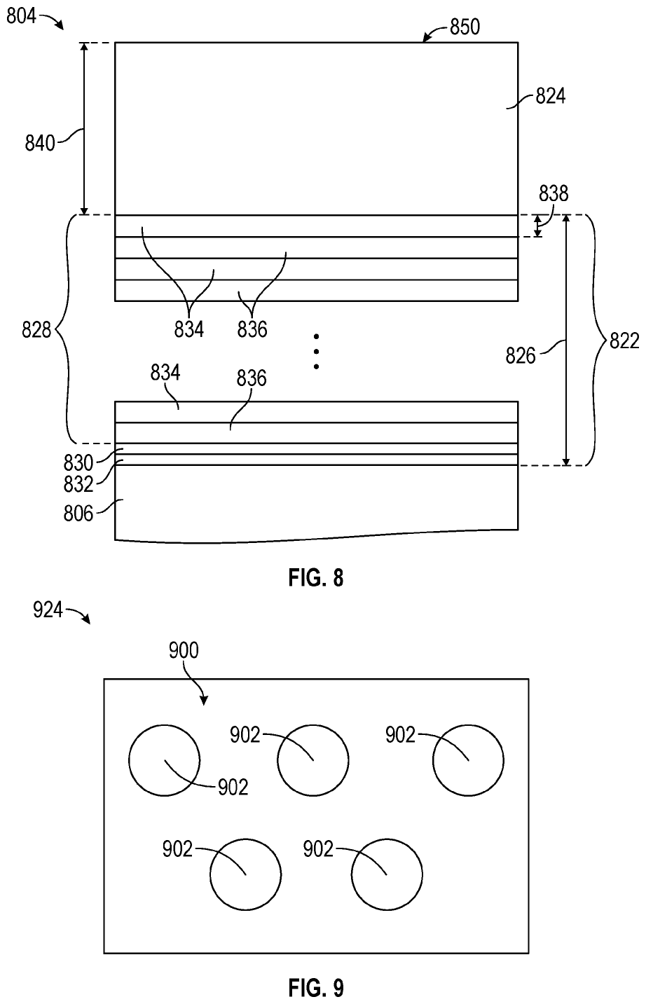

Various types of inorganic particles, fluoropolymers, microporous (or micro-voided) polymer layers, multilayer optical films (such as solar mirror films), and metal layers are described further herein. In particular, at least one example of a multilayer optical film is shown in FIG. 8.

Various suitable materials and structures may be used to at least partially (or entirely) define the high absorbance in the atmospheric infrared region for the plurality of solar mirror element 104. Non-limiting examples of materials and structures that may be used to at least partially (or entirely) define the high absorbance in the atmospheric infrared region include: a dense fluoropolymer layer, a microporous (or micro-voided) fluoropolymer layer, a dense polyester layer at least partially (or entirely) covered by a dense fluoropolymer layer, a microporous (or micro-voided) polyester layer at least partially (or entirely) covered by a dense fluoropolymer layer, a microporous (or micro-voided) polyester layer at least partially (or entirely) covered by a microporous (or micro-voided) fluoropolymer layer, and a multilayer optical film.

In some embodiments, at least some (or all) of the solar mirror element 104 may include various structures, which may contribute to the high absorbance in the atmospheric infrared region. In some embodiments, inorganic particles may be provided as surface or embedded structures on or in material of the plurality of solar mirror element 104, such as embedded in any polymer layer (such as a dense polymer layer, a microporous (or micro-voided) polymer layer, or a multilayer optical film), to contribute to the high absorbance in the atmospheric infrared region. In some embodiments, the inorganic particles may be, or include, white inorganic particles, which may at least partially (or entirely) define a high average reflectance in the solar region. Any suitable white inorganic particles may be used known to one skilled in the art having the benefit of the present disclosure.

Inorganic particles may include barium sulfate, calcium carbonate, silica, alumina, aluminum silicate, zirconia, zinc oxide, or titania. The inorganic particles may be in the form of nanoparticles, such as nanotitania, nanosilica, nanozironia, or even nano-scale zinc oxide particles. The inorganic particles may be in the form of beads or microbeads. The inorganic particles may be formed of a ceramic material, glass (such as in the form of glass beads or glass bubbles), or various combinations of thereof. In some embodiments, the inorganic particles have an effective D90 particle size of greater than or equal to 0.1 micrometer (in some embodiments, at least 1, 2, 3, 5, 6, 7, 8, 9, 10, or even at least 13 micrometers). In some embodiments, the inorganic particles have an effective D90 particle size of less than or equal to 50 micrometers (in some embodiments, less than or equal to 45, 40, 35, 30, 25, 20, 15, 14, 13, 12, 11, 10, 9, or even at most 8 micrometers).

As defined in NIST “Particle Size Characterization,” ASTM E-2578-07 (2012) describes D90 as the intercept where 90% of the samples mass has particles with a diameter less than the value. For example, a D90 of 10 micrometers specifies that 90% of the samples mass includes particles with diameters less than 10 micrometers. Particle diameter may be measured with a particle size analyzer (for example, available under the trade designation “HORIBA PARTICLE SIZE ANALYZER” from Flow Sciences, Inc., Leland, N.C.).

Non-limiting examples of ceramic microspheres that may be used as inorganic particles ceramic microspheres available under the trade designations “3M CERAMIC MICROSPHERES WHITE GRADE W-710” (alkali aluminosilicate ceramic, effective D90 particle size of 12 micrometers), “3M CERAMIC MICROSPHERES WHITE GRADE W-1410” (alkali aluminosilicate ceramic, effective D90 particle size of 21 micrometers), “3M CERAMIC MICROSPHERES WHITE GRADE W-610” (alkali aluminosilicate ceramic, effective D90 particle size of 32 micrometers), from 3M Company, or various combinations thereof. In general, various combinations of inorganic particles of the same or different size may be used.

Various suitable materials and structures may be used to at least partially (or entirely) define the high average reflectance in the solar region for the plurality of solar mirror element 104. Non-limiting examples of materials and structures that may be used to at least partially (or entirely) define the high average reflectance in the solar region include: a metal layer at least partially (or entirely) defining a high average reflectance in the solar wavelength range, a microporous (or micro-voided) polymer layer, and a multilayer optical film. In some embodiments, one or more of the structures also include white inorganic particles, such as any polymer layer or multilayer optical film, that at least partially (or entirely) define a high average reflectance in the solar region.

The first major surface 114 include a textured surface. Some textures (for example, depending on the dimensions of the various surface structures relative to the wavelength of electromagnetic radiation) may enhance the passive cooling effects achieved by the article 102 as a whole. While one purpose of texturing the first major surface 114 to include surface structures may be to provide radiative cooling, texturing may also provide additional benefits, such as drag resistance or antisoiling. Various types of surface structures may include surface microstructures or surface nanostructures, which may be discrete or continuous.

In some embodiments, at least some of the plurality of solar mirror element 104 may define various anti-drag surface structures to provide a reduction in drag resistance. In some embodiments, the article 102 may be applied to the surface of a vehicle. The texturing may achieve drag reduction, for example, when the vehicle moves through the air. The presence of surface microstructures or nanostructures may result in a lowered coefficient of friction between the surface and the air through which the vehicle is moving, which can result in cost or fuel savings. Any suitable shape may be used to form the anti-drag surface structures, for example, similar to the shapes shown in FIGS. 3-13 and 19-21.

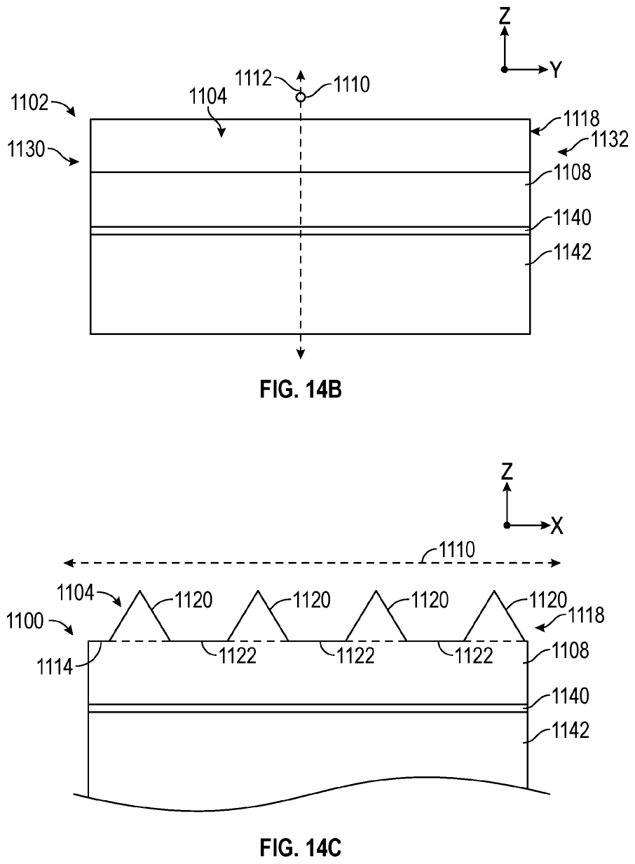

In some embodiments, at least some of the plurality of solar mirror element 104 may define various antisoiling surface structures, which may contribute to dirt resistance and antisoiling properties. In some embodiments, antisoiling surface structures may be defined in, or on, at least some of the first major surface 114 to contribute to dirt resistance or antisoiling properties. Non-limiting examples of antisoiling surface structures for dirt resistance and antisoiling properties are shown in FIGS. 14A-21.

Any suitable fluoropolymer material may be used in the article 102. Non-limiting examples of fluoropolymers that may be used include: a polymer of tetrafluoroethylene (TFE), hexafluoropropylene (HFP), and vinylidene fluoride (for example, available under the trade designation “3M DYNEON THV” from 3M Company), a polymer of TFE, HFP, vinylidene fluoride, and perfluoropropyl vinyl ether (PPVE) (for example, available under the trade designation “3M DYNEON THVP” from 3M Company), a polyvinylidene fluoride (PVDF) (for example, “3M DYNEON PVDF 6008” available from 3M Company), an ethylene chlorotrifluoroethylene (ECTFE) polymer (for example, available under the trade designation “HALAR 350LC ECTFE” from Solvay, Brussels, Belgium), an ethylene tetrafluoroethylene (ETFE) (for example, available under the trade designation “3M DYNEON ETFE 6235” from 3M Company), a perfluoroalkoxy alkane (PFA) polymer, a fluorinated ethylene propylene (FEP) polymer, a polytetrafluoroethylene (PTFE), a polymer of TFE, HFP, and ethylene (for example, available under the trade designation “3M DYNEON HTE1705” from 3M Company), or various combinations thereof. In general, various combinations of fluoropolymers can be used. In some embodiments, the fluoropolymer includes FEP. In some embodiments, fluoropolymer includes PFA.

Examples of fluoropolymers include those available, for example, from 3M Company under the trade designations “3M DYNEON THV221GZ” (39 mol % tetrafluoroethylene, 11 mol % hexafluoropropylene, and 50 mol % vinylidene fluoride), “3M DYNEON THV2030GZ” (46.5 mol % tetrafluoroethylene, 16.5 mol % hexafluoropropylene, 35.5 mol % vinylidene fluoride, and 1.5 mol % perfluoropropyl vinyl ether), “3M DYNEON THV610GZ” (61 mol % tetrafluoroethylene, 10.5 mol % hexafluoropropylene, and 28.5 mol % vinylidene fluoride), and “3M DYNEON THV815GZ” (72.5 mol % tetrafluoroethylene, 7 mol % hexafluoropropylene, 19 mol % vinylidene fluoride, and 1.5 mol % perfluoropropyl vinyl ether). Examples of fluoropolymers also include PVDF available, for example, under the trade designations “3M DYNEON PVDF 6008” and “3M DYNEON PVDF 11010” from 3M Company; FEP available, for example, under the trade designation “3M DYNEON FLUOROPLASTIC FEP 6303Z” from 3M Company; and ECTFE available, for example, under the trade designation “HALAR 350LC ECTFE” from Solvay.

Any suitable microporous (or micro-voided) polymer layer (or film) may be used. In general, a microporous layer may include a network of interconnected voids or discrete voids, which may be spherical, oblate, or some other shape. The microporous layer may reflect at least a portion of visible and infrared radiation of the solar spectrum and may emit thermal radiation in the atmospheric infrared region and may be described as a reflective microporous layer. The reflective microporous layer may have voids that are of appropriate size that diffusely reflect wavelengths in the solar region (such as 0.4 to 2.5 micrometers). Generally, this means that the void sizes should be in a particular size range (such as 100 to 10,000 nanometers). A range of void sizes corresponding to those dimensions may facilitate effective broadband reflection.

Reflectivity of the reflective microporous layer is generally a function of the number of polymer film-void interfaces, since reflection (typically diffuse reflection) occurs at those locations. The porosity and thickness of the reflective microporous layer may be selected accordingly. In general, higher porosity and higher thickness correlate with higher reflectivity. In some applications, film thickness may be minimal to reduce cost. The thickness of the reflective microporous layer may be in the range of 10 to 500 micrometers (or in the range of 10 to 1200 micrometers). Likewise, the porosity of the reflective microporous layer may be in the range of 10 to 90 volume percent (or in the range of 20 to 85 volume percent).

Microporous polymer films that may be suitable for use as the reflective microporous layer are described, for example, in U.S. Pat. No. 8,962,214 (Smith et al.) entitled “Microporous PVDF Films”, in U.S. Pat. No. 10,240,013 (Mrozinski et al.) entitled “Microporous Material from Ethylene-Chlorotrifluoroethylene Copolymer and Method for Making Same”, and in U.S. Pat. No. 4,874,567 (Lopatin et al.) entitled “Microporous Membranes from Polypropylene,” which are incorporated herein by reference. These films may have average pore diameters of at least 0.05 micrometers.

In certain embodiments, the reflective microporous layer includes at least one Thermally Induced Phase Separation (TIPS) material. The pore size of TIPS materials can be generally controlled due to the ability to select the extent of stretching of the layer. Various materials and methods for making TIPS materials are described in detail in U.S. Pat. No. 4,726,989 (Mrozinski), U.S. Pat. No. 5,238,623 (Mrozinski), U.S. Pat. No. 5,993,954 (Radovanovic et al.), and U.S. Pat. No. 6,632,850 (Hughes et al.).

Reflective microporous layers that may be used may also include Solvent Induced Phase Separated (SIPS) materials (such as described in U.S. Pat. No. 4,976,859 (Wechs)) and other reflective microporous layers made by extrusion, extrusion-stretching and extrusion-stretching-extraction processes. Suitable reflective microporous layers that may be formed by SIPS may include polyvinylidene fluoride (PVDF), polyether sulfone (PES), polysulfone (PS), polyacrylonitrile (PAN), nylon (i.e., polyamide), cellulose acetate, cellulose nitrate, regenerated cellulose, or polyimide. Suitable reflective microporous layers that may be formed by stretching techniques (such as described in U.S. Pat. No. 6,368,742 (Fisher et al.)) may include polytetrafluoroethylene (PTFE) or polypropylene.

In some embodiments, the reflective microporous layer includes a thermoplastic polymer, for instance polyethylene, polypropylene, 1-octene, styrene, polyolefin copolymer, polyamide, poly-1-butene, poly-4-methyl-1-pentene, polyethersulfone, ethylene tetrafluoroethylene, polyvinylidene fluoride, polysulfone, polyacrylonitrile, polyamide, cellulose acetate, cellulose nitrate, regenerated cellulose, polyvinyl chloride, polycarbonate, polyethylene terephthalate, polyimide, polytetrafluoroethylene, ethylene chlorotrifluoroethylene, or combinations thereof.

In some embodiments, materials suitable for use as the reflective microporous layer may include nonwoven fibrous layers. Nonwoven fibrous layers may be made using a melt blown or melt spinning process, which may include using: polyolefins such as polypropylene and polyethylene, polyester (such as polyethylene terephthalate (PET)), polybutylene terephthalate, polyamide, polyurethane, polybutene, polylactic acid, polyphenylene sulfide, polysulfone, liquid crystalline polymer, polyethylene-co-vinyl acetate, polyacrylonitrile, cyclic polyolefin, and copolymers and blends thereof. In some embodiments, the polymer, copolymer, or blend thereof represents at least 35% of the overall weight of the directly formed fibers present in the nonwoven fibrous layer.

Nonwoven fibers can be made from a thermoplastic semi-crystalline polymer, such as a semi-crystalline polyester. Useful polyesters include aliphatic polyesters. Nonwoven materials based on aliphatic polyester fibers can be especially advantageous in resisting degradation or shrinkage at high temperature applications.

Some embodiments of microporous membrane fabricated with nonwoven fibers are highly reflective white papers including polysaccharides. Microporous polysaccharide white papers having greater than 90% reflectance over visible wavelengths of 400 to 700 nanometers are available from International Paper, Memphis, Tenn., under the trade designations “IP ACCENT OPAQUE DIGITAL (100 lbs)”, “IP ACCENT OPAQUE DIGITAL (100 lbs)”, “HAMMERMILL PREMIUM COLOR COPY (80 lbs)”, and “HAMMERMILL PREMIUM COLOR COPY (100 lbs).” Titania, BaSO4 and other white pigments are often added to paper to increase their reflection of visible light (400-700 nanometers).

Other nonwoven fibrous layers that may be used for the reflective microporous layer include those made using a wet laid process. Suitable fibers for use in air laid and wet laid processes include those made from natural (animal or vegetable) and/or synthetic polymers, including thermoplastic and solvent-dispersible polymers. Useful polymers include wool; silk; cellulosic polymers (for example, cellulose and cellulose derivatives); fluorinated polymers (for example, polyvinyl fluoride, polyvinylidene fluoride, copolymers of vinylidene fluoride such as poly(vinylidene fluoride-co-hexafluoropropylene), and copolymers of chlorotrifluoroethylene such as poly(ethylene-co-chlorotrifluoroethylene)); chlorinated polymers; polyolefins (for example, polyethylene, polypropylene, poly-1-butene, copolymers of ethylene and/or propylene, with 1-butene, 1-hexene, 1-octene, and/or 1-decene (for example, poly(ethylene-co-1-butene), poly(ethylene-co-1-butene-co-1-hexene)); polyisoprenes; polybutadienes; polyamides (for example, nylon 6, nylon 6,6, nylon 6,12, poly(iminoadipoyliminohexamethylene), poly(iminoadipoyliminodecamethylene), or polycaprolactam); polyimides (for example, poly(pyromellitimide)); polyethers; polyether sulfones (for example, poly(diphenyl ether sulfone), or poly(diphenyl sulfone-co-diphenylene oxide sulfone)); polysulfones; polyvinyl acetates; copolymers of vinyl acetate (for example, poly(ethylene-co-vinyl acetate), copolymers in which at least some of the acetate groups have been hydrolyzed to provide various poly(vinyl alcohols) including poly(ethylene-co-vinyl alcohol)); polyphosphazenes; polyvinyl esters; polyvinyl ethers; poly(vinyl alcohols); polyaramids (for example, para-aramids such as poly(paraphenylene terephthalamide) and fibers sold under the trade designation KEVLAR by DuPont Co., Wilmington, Del., pulps of which are commercially available in various grades based on the length of the fibers that make up the pulp such as, for example, KEVLAR 1F306 and KEVLAR 1F694, both of which include aramid fibers that are at least 4 mm in length); polycarbonates; and combinations thereof. Nonwoven fibrous layers may be calendared to adjust the pore size.

The use of a reflective micro-voided polymer film as the reflective microporous layer may provide a reflectance that is even greater than that of a silvered mirror. In some embodiments, a reflective micro-voided polymer film has a high average reflectance in the solar region. In particular, the use of a fluoropolymer blended into the micro-voided polymer film may provide a high average reflectance that may be greater than other types of multilayer optical films. Examples of polymers useful for forming the reflective micro-voided polymer film include polyester (or polyethylene terephthalate (PET)) available from 3M Company. Modified PET copolyesters including PETG available, for example, as SPECTAR 14471 and EASTAR GN071 from Eastman Chemical Company of Kingsport, Tenn., and PCTG available, for example, as TIGLAZE ST and EB0062 also from Eastman Chemical Company are also useful high refractive index polymers. The molecular orientation of PET and PET modified copolyesters may be increased by stretching which increases its in-plane refractive indices providing even more reflectivity in the multilayer optical film. In general, an incompatible polymer additive, or inorganic particle additive, is blended into the PET host polymer at levels of at least 5 wt. %, 10 wt. %, at least 20 wt. %, at least 30 wt. %, at least 40 wt. %, or even at least 49 wt. % during extrusion prior to stretching to nucleate voids during the stretching process. Suitable incompatible polymers additives for PET include: fluoropolymers, polypropylenes, polyethylenes, and other polymers which do not adhere well to PET. Cross-linked polymer beads such as those available from Soken Chemical and Engineering Co. under the trade designation “CHEMISNOW” can be effective void nucleating agents. Glass beads such as those available from Potters Industries LLC under the trade designation “SPHERIGLASS” can be effective nucleating agents. Similarly, if polypropylene is the host polymer, then incompatible polymer additives such as PET or fluoropolymers or cross-linked polymer beads or glass beads can be added to the polypropylene host polymer at levels of at least 10 wt. %, at least 20 wt. %, at least 30 wt. %, at least 40 wt. %, or even at least 49 wt. % during extrusion prior to stretching to nucleate voids during the stretching process.

Examples of suitable inorganic particle additives for nucleating voids in micro-voided polymer films include titania, silica, alumina, aluminum silicate, zirconia, calcium carbonate, barium sulfate, and glass beads and hollow glass bubbles, although other inorganic particles and combinations of inorganic particles may also be used. Crosslinked polymeric microspheres can also be used instead of inorganic particles. Inorganic particles can be added to the host polymer at levels of at least 10 wt. %, at least 20 wt. %, at least 30 wt. %, at least 40 wt. %, or even at least 49 wt. % during extrusion prior to stretching to nucleate voids during the stretching process. If present, the inorganic particles may have a volume average particle diameter of 5 nanometers to 1 micrometer, although other particle sizes may also be used. Hard particles including glass beads or glass bubbles can be present on the surface layer of UV mirror skin layer or the antisoiling layer to provide scratch resistance. In some embodiments, glass beads and/or glass bubbles may even protrude from the surface as hemispheres or even quarter spheres.

In some embodiments, micro-voided polymer films include a fluoropolymer continuous phase. Examples of suitable polymers include ECTFE, PVDF, and copolymers of tetrafluoroethylene, hexafluoropropylene, and vinylidene fluoride such as, for example, those available under the trade designation THV from 3M Company.

An example of micro-voided PET film including barium sulfate is available as LUMIRROR XJSA2 from Toray Plastics (America) Inc. of North Kingstown, R.I. LUMIRROR XJSA2 includes BaSO4 inorganic additive to increase its reflectivity of visible light (400-700 nanometers). Additional examples of reflective micro-voided polymer films are available from Mitsubishi Polymer Film, Inc. of Greer, S.C., as HOSTAPHAN V54B, HOSTAPHAN WDI3, and HOSTAPHAN W270.

Some examples of micro-voided polyolefin films are described in, for example, U.S. Pat. No. 6,261,994 (Bourdelais et al.).

The reflective microporous layer is generally diffusely reflective, for example, of visible radiation over a majority of wavelengths in the range of 400 to 700 nanometers, inclusive. In some embodiments, the reflective microporous layer may have an average reflectance of at least 60% (in some embodiments, at least 70%, 80%, 85%, 90%, 91%, 92%, 93%, 94%, 95%, 96%, 97%, 98%, 99%, or even at least 99.5%) over a wavelength range of at least 400 up to 700 nanometers.

The reflectivity of the reflective microporous layer may be reflective over a broader wavelength range. In some embodiments, the reflectivity of the microporous polymer layer may have an average reflectance of at least 60% (in some embodiments, at least 70%, 80%, 85%, 90%, 91%, 92%, 93%, 94%, 95%, 96%, 97%, 98%, 99%, or even at least 99.5%) over the solar region, such as a wavelength range of from 0.4 to 2.5 micrometers (or even from 0.3 to 3.0 micrometers).

Any suitable material may be used to at least partially (or entirely) form at least some (or all) of the coolable element 106. Non-limiting examples of metals that may be used in the coolable element 106 include one or more of the following: silver (Ag), copper (Cu), aluminum (Al), gold (Au), Inconel, stainless steel, or various combinations thereof. In some embodiments, a metal layer may be formed including a layer of silver and a thin (20-nanometer thick) layer of copper to protect the silver from corrosion. In some embodiments, the metal layer may at least partially (or entirely) define a high average reflectance at least in the solar wavelength range. Additionally, or alternatively, any metal layer may be vapor coated.

A metal layer, such as the thermal spreading element 220, may be bent, for example, using a metal bending machine, to provide first portions of the metal layer at different angles than the second portions. In some embodiments, the first portions may be used to support and orient one solar mirror element 104, and the second portions may be used to support and orient the energy absorber 108 (see FIG. 4).

Any suitable techniques may be used to form the article 102. In some embodiments, when the thermal spreading element 220 is formed of a metal, a sheet of metal (such as aluminum) may be bent using a metal bending machine. Metal bending machines, often called brakes, can be used to form sheet metal into the desired form factor of article 102. Metal bending machines are commercially available from companies such as Bolton Tools, Baileigh Industrial, and RAMS Sheet metal equipment.

In some embodiments, the solar mirror element 104 including polymer may be formed by thermoforming. In some embodiments, article 102 may be thermoformed from thermoformable polymer sheet with commonly available polymer sheet thermoformers. Thermoforming machines are generally commercially available from companies such as Belovac Industries, Sencorpwhite, and Formech Inc. In some embodiments, laminated strips or discrete portions may be applied to a supporting layer prior to thermoforming or metal bending any elements.

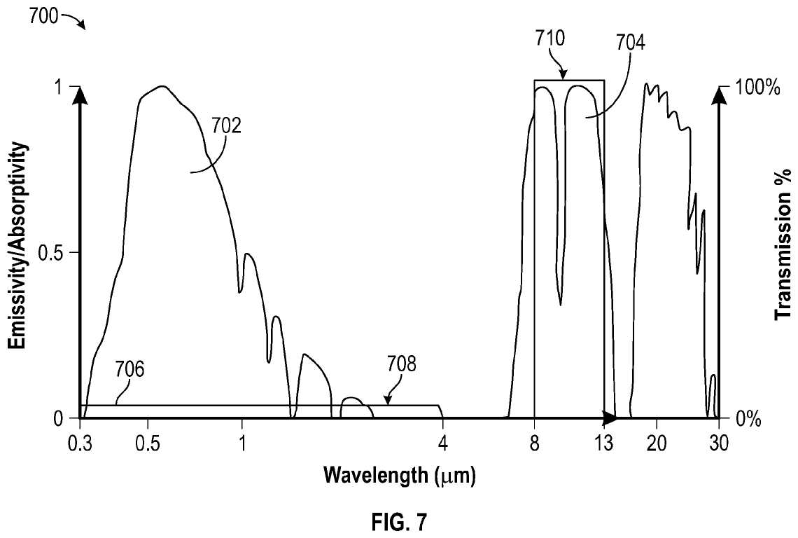

FIG. 7 is a graph 700 of: an energy spectrum 702 of solar energy (or sunlight) described as terrestrial reference spectrum found in ASTM G173-03 (2012), an energy transmission % spectrum 704 in an atmospheric infrared region (for example, from 0 to 100%), and one example of an absorption 706 (for example, absorptivity or emissivity, as shown on the y-axis from 0 to 1) of high emissivity elements of an article, such as the solar mirror element 104 (FIG. 1). Absorption 706 may also be described in terms of absorbance (for example, the logarithm of the reciprocal of transmission).

High emissivity elements may define reflectors to reflect some or all the light of the energy spectrum 702 in the reflective band 708. The reflective band 708 at least partially (or entirely) covers wavelengths in the solar region and, in some cases (such as an infrared mirror film), at least partially (or entirely) covers wavelengths in the visible, near-infrared, or mid-infrared regions. Reflectors may have low absorption 706 in the reflective band 708.

High emissivity elements may have a high absorption 706 in an absorptive band 710. The absorptive band 710 may at least partially (or entirely) cover the wavelengths in the atmospheric infrared region, which may facilitate transmitting at least some infrared energy (for example, from any article of the present disclosure) through the high transmission regions of the atmosphere, for example, as shown by the energy transmission % spectrum 704. High emissivity elements may have low reflectivity in the absorptive band 710.

FIG. 8 is a schematic illustration of one example of a solar mirror element 804 that includes a multilayer optical film, which may be used as the solar mirror element 104 of FIG. 1. The solar mirror element 804 may be applied to the coolable element 806, which may be used as the coolable element 106 of FIG. 1. The solar mirror element 804 may be used to reflect solar energy 118 (FIG. 1) in the solar wavelength range and radiate light in the atmospheric infrared wavelength range. The solar mirror element 804 may include multiple components, which may cooperatively provide reflective properties and absorptive properties described herein to direct solar energy 118 to the energy absorber 108 (FIG. 1) and to cool the coolable element 806. In some embodiments, the solar mirror element 804 is thermally coupled to the coolable element 806 to transfer heat therebetween. In some embodiments, the coolable element 806 is coupled to a fluid, liquid or gas, which can transfer heat away from another article or subsystem (such as a heat exchanger, building, battery, refrigerator, freezer, air conditioner, or photovoltaic module).

In some embodiments, such as the one depicted, the solar mirror element 804 may include a reflector 822 with high average reflectance in the solar region to reflect light in the solar region and may have an outer layer 824 with a high transmittance in the solar region to allow light to pass through to the reflector. The outer layer 824 may define an outer surface 850. The outer surface 850 may at least partially define the first major surface 114 (FIG. 1) or at least the first region 430 of the first major surface 414 (FIG. 4). The outer layer 824 may also have a high absorbance in the atmospheric infrared region to radiate energy in wavelengths of the atmospheric infrared region away from the article. In some embodiment, the outer layer 824 is thermally coupled to the reflector 822 to transfer heat therebetween. Heat from the coolable element 806 transferred to the reflector 822 may be further transferred to the outer layer 824, which may be radiated as light in the atmospheric infrared region to cool the coolable element 806 at night and during the day.

The outer layer 824 may partially or fully cover the reflector 822. In general, the outer layer 824 may be positioned between the reflector 822 and at least one source of solar energy (for example, the sun). The outer layer 824 may be exposed to elements in an outdoor environment and may be formed of material particularly suited for such environments.

The outer layer 824 may be formed of material that provides high transmittance in the solar region or high absorptivity in the atmospheric infrared region, or both. The material of the outer layer 824 may include at least one polymer (for example, a fluoropolymer).

The reflector 822 may partially or fully cover the coolable element 806. In general, the reflector 822 may be positioned between the coolable element 806 and the outer layer 824 or at least one source of solar energy. The reflector 822 may be protected from environmental elements by the outer layer 824.

In some embodiments, the reflector 822 may be thin to facilitate heat transfer from the coolable element 806 to the outer layer 824. In general, a thinner reflector 822 may provide better heat transfer. In some embodiments, the overall thickness 826 of the reflector 822 is less than or equal to 50 micrometers (in some embodiments, less than or equal to 40, 30, 25, 20, 15, or even at most 10 micrometers).

In the illustrated embodiment, the reflector 822 includes a multilayer optical film 828 and may include a metal layer 830. The metal layer 830 (described herein in more detail) may be disposed between the film 828 and the coolable element 806. The film 828 may be disposed between the outer layer 824 and the coolable element 806. The film 828 may be coupled to the coolable element 806, for example, by an adhesive layer 832 (or backing layer). The adhesive layer 832 may be disposed between the metal layer 830 and the coolable element 806. The adhesive layer may include thermally conductive particles to aid in heat transfer. Thermally conductive particles include aluminum oxide and alumina nanoparticles. Additional thermally conductive particles for the adhesive layer include those available under the trade designation “3M BORON DINITRIDE” from 3M Company. Suitable thermally conductive adhesives include those available from 3M Company under the trade designation “3M THERMALLY CONDUCTIVE ADHESIVE TRANSFER TAPES 8805” and “3M THERMALLY CONDUCTIVE EPDXY ADHESIVE TC-2707.” In some embodiments, thermally conductive adhesive can be substituted with thermally conductive pastes such as those available from Amec Thermasol under the trade designation “MSC-10” and from Honeywell Inc under the trade designation “107408 HEAT CONDUCTIVE COMPOUND.”

The film 828 may include at least layer that defines the reflective band 708 (FIG. 7). In some embodiments, film 828 includes plurality of first optical layers 834 and plurality of second optical layers 836. The layers 834, 836 in the film 828 may alternate or be interleaved and have different refractive indices. Each first optical layer 834 may be adjacent to a second optical layer 836, or vice versa. Most of the first optical layers 834 may be disposed between adjacent second optical layers 836, or vice versa (for example, all layers except one).

The reflective band 708 may be defined by the number of optical layers, the thicknesses, and the refractive indices of the optical layers 834, 836 in any suitable manner known to one skilled in the art of making reflective multi-layer optical films having the benefit of the present disclosure.

In some embodiments, the film 828 has up to 1000 total optical layers 834, 836 (in some embodiments, up to 700, 600, 500, 400, 300, 250, 200, 150, or even up to 100 total optical layers).

The thicknesses of the optical layers 834, 836 in one film 828 may vary. The optical layers 834, 836 may each define a maximum thickness 838. Some of the optical layers 834, 836 may be thinner than the maximum thickness 838. The maximum thickness 838 of optical layers 834, 836 may be much smaller than a minimum thickness 840 of the outer layer 824. The outer layer 824 may also be described as a skin layer. In some embodiments, the outer layer 824 may provide structural support for the film 828, particularly when the outer layer 824 is co-extruded with the film 828. In some embodiments, the minimum thickness 840 of the outer layer 824 is at least 5 (in some embodiments, at least 10, or even at least 15) times greater than the maximum thickness 838 of the optical layers 834, 836.

The refractive indices of the optical layers 834, 836 may be different. The first optical layer 834 may be described as a low index layer and the second optical layer 836 may be described as a high index layer, or vice versa. In some embodiments, a first refractive index (or average refractive index) of the low index layers is less than a second refractive index (or average refractive index) of the high index layers by greater than or equal to 4% (in some embodiments, greater than or equal to 5, 10, 12.5, 15, 20, or even at least 25%). In some embodiments, the first refractive index of the low index layer may be less than or equal to 1.5 (in some embodiments, less than or equal to 1.45, 1.4, or even at most 1.35). In some embodiments, the second refractive index of the high index layer may be greater than or equal to 1.4 (in some embodiments, greater than or equal to 1.42, 1.44, 1.46, 1.48, 1.5, 1.6, or even at least 1.7).

The film 828 may be formed of at least one material that provide high average reflectance in the solar region. The material of the film 828 may include at least one polymer. One type of polymeric material is a fluoropolymer. At least one of the materials used to form the film 828 may be the same or different as at least one material used to form the outer layer 824. In some embodiments, both the film 828 and the outer layer 824 may include a fluoropolymer. The composition of the fluoropolymers may be the same or different in the film 828 compared to the outer layer 824.

In some embodiments, the first optical layer 834 is formed of different material than second optical layer 836. One of first and second optical layers 834, 836 may include a fluoropolymer. The other of first and second optical layers 834, 836 may include a fluoropolymer or include a non-fluorinated polymer. In some embodiments, the first optical layer includes a fluoropolymer and the second optical layer includes a non-fluorinated polymer.

In some embodiments, multilayer optical films described herein can be made using general processing techniques, such as those described in U.S. Pat. No. 6,783,349 (Neavin et al.), which is incorporated herein by reference.

Desirable techniques for providing a multilayer optical film with a controlled spectrum may include, for example, (1) the use of an axial rod heater control of the layer thickness values of coextruded polymer layers as described, for example, in U.S. Pat. No. 6,783,349 (Neavin et al.); (2) timely layer thickness profile feedback during production from a layer thickness measurement tool such as, for example, an atomic force microscope (AFM), a transmission electron microscope, or a scanning electron microscope; (3) optical modeling to generate the desired layer thickness profile; and (4) repeating axial rod adjustments based on the difference between the measured layer profile and the desired layer profile.

In some embodiments, the basic process for layer thickness profile control may involve adjustment of axial rod zone power settings based on the difference of the target layer thickness profile and the measured layer profile. The axial rod power increase needed to adjust the layer thickness values in a given feedblock zone may first be calibrated in terms of watts of heat input per nanometer of resulting thickness change of the layers generated in that heater zone. For example, fine control of the spectrum is possible using 24 axial rod zones for 275 layers. Once calibrated, the necessary power adjustments can be calculated once given a target profile and a measured profile. The procedure is repeated until the two profiles converge.

In one embodiment, articles of the present disclosure may include a UV light reflective multi-layer optical film, which may be described as a UV reflecting multi-layer optical film, reflecting a wavelength range from 300 to 450 nanometers made with 150 high refractive index layers including a CoPMMA (for example, available under the trade designation “PERSPEX CP63” from Lucite International of Cordova, Tenn.) alternating with 150 low refractive index layers including a fluoropolymer (for example, available under the trade designation “3M DYNEON THV221” from 3M Company), and a visible light reflective multi-layer optical film reflecting a wavelength range from 450 to 750 nanometers made with 150 high refractive index layers including a PET (for example, available under the trade designation “EASTAPAK 7452” from Eastman Chemical Company, Kingsport, Tenn.), alternating with 150 low refractive index layers including a fluoropolymer (for example, available under the trade designation “3M DYNEON THV221” from 3M Company). The surface of the visible light reflective multi-layer optical film opposite the UV light reflective multi-layer optical film is coated with 100 nanometers of copper (Cu). The surface of the UV light reflective multilayer optical film opposite the visible light reflective mirror is a layer having fluoropolymer (for example, available under the trade designation “3M DYNEON THV815” from 3M Company).

Non-limiting examples of non-fluorinated polymers (polymers without fluorine) that may be used include at least one of: a polyethylene terephthalate (PET), a co-polymer of ethyl acrylate and methyl methacrylate (co-PMMA), a polypropylene (PP), a polyethylene (PE), a polyethylene copolymer, a polymethyl methacrylate (PMMA), an acrylate copolymer, a polyurethane, or various combinations thereof. In general, various combinations of non-fluorinated polymers can be used.

Examples of isotropic optical polymers, especially for use in the low refractive index optical layers, may include homopolymers of polymethylmethacrylate (PMMA), such as those available from Ineos Acrylics, Inc., Wilmington, Del., under the trade designations “CP71” and “CP80;” and polyethyl methacrylate (PEMA), which has a lower glass transition temperature than PMMA. Additional useful polymers include copolymers of PMMA (CoPMMA), such as a CoPMMA made from 75 wt. % methylmethacrylate (MMA) monomers and 25 wt. % ethyl acrylate (EA) monomers, (for example, available under the trade designation “PERSPEX CP63” from Ineos Acrylics, Inc., or available under the trade designation “ATOGLAS 510” from Arkema, Philadelphia, Pa.), a CoPMMA formed with MMA comonomer units and n-butyl methacrylate (nBMA) comonomer units, or a blend of PMMA and poly(vinylidene fluoride) (PVDF). Additional examples of optical polymers for Layer A include acrylate triblock copolymers, where each endblock of at least one of the first block copolymer, the second block copolymer, or the at least one additional block copolymer is formed of poly(methyl methacrylate), and further wherein each midblock of at least one of the first block copolymer or the second block copolymer is formed of poly(butyl acrylate). In some embodiments, at least one of the first block copolymer, the second block copolymer, or the at least one additional block copolymer is formed of from 30 wt. % to 80 wt. % endblocks, and from 20 wt. % to 70 wt. % midblocks, based on a total weight of the respective block copolymer. In certain particular embodiments, at least one of the first block copolymer, the second block copolymer, or the at least one additional block copolymer is formed of from 50 wt. % to 70 wt. % endblocks, and from 30 wt. % to 50 wt. % midblocks, based on the total weight of the respective block copolymer. In any of the foregoing embodiments, the first block copolymer may be selected to be the same as the second block copolymer. Triblock acrylate copolymers are available, for example, under the trade designation “KURARITY LA4285” from Kuraray America, Inc., Houston, Tex.

Additional suitable polymers for the optical layers, especially for use in the low refractive index optical layers, may include at least one of: polyolefin copolymers, such as poly (ethylene-co-octene) (PE-PO) (for example, available under the trade designation “ENGAGE 8200” from Dow Elastomers, Midland, Mich.), poly (propylene-co-ethylene) (PPPE) (for example, available under the trade designation “Z9470” from Atofina Petrochemicals, Inc., Houston, Tex.), and a copolymer of atactic polypropylene (aPP) and isotactic polypropylene (iPP). The multilayer optical films can also include, for example, in the second layers, a functionalized polyolefin, such as linear low-density polyethylene-graft-maleic anhydride (LLDPE-g-MA) (for example, available under the trade designation “BYNEL 4105” from E.I.du Pont de Nemours & Co., Inc., Wilmington, Del.).

Material may be selected based on absorbance or transmittance properties described herein, as well as on refractive index. In general, the greater the refractive index between two materials in the film 828, the thinner the film can be, which may be desirable for efficient heat transfer.

Examples of polymers useful for forming the high refractive index optical layers include polyethylene terephthalate (PET), available from 3M Company, and also available from Nan Ya Plastics Corporation, Wharton, Tex. Copolymers of PET including PETG and PCTG under the trade designation “SPECTAR 14471” and “EASTAR GN071” from Eastman Chemical Company, Kingsport, Tenn., are also useful high refractive index layers. The molecular orientation of PET and CoPET may be increased by stretching which increases its in-plane refractive indices providing even more reflectivity in the multilayer optical film.

UV stabilization with UV-absorbers (UVAs) and Hindered Amine Light Stabilizers (HALs) can intervene in the prevention of photo-oxidation degradation of PETs, PMMAs, and CoPMMAs. UVAs for incorporation into PET, PMMA, or CoPMMA optical layers include benzophones, benzotriazoles, and benzotriazines. Examples of UVAs for incorporation into PET, PMMA, or CoPMMA optical layers include those available under the trade designations “TINUVIN 1577” and “TINUVIN 1600,” from BASF Corporation, Florham Park, N.J. Typically, UVAs are incorporated in the polymer at a concentration of 1-10 wt %. Examples of HALs for incorporation into PET, PMMA, or CoPMMA optical layers include those available under the trade designations “CHIMMASORB 944” and “TINUVIN 123,” from BASF Corporation. Typically, the HALs are incorporated into the polymer at are 0.1-1.0 wt %. A 10:1 ratio of UVA to HALs can be optimum.

UVAs and HALs can also be incorporated into the fluoropolymer surface layer, or a fluoropolymer layer below the surface layer. U.S. Pat. No. 9,670,300 (Olson et al.) and U.S. Patent App. Pub. No. 2017/0198129 (Olson et al.), which are incorporated herein by reference, describe examples of UVA oligomers that are compatible with PVDF fluoropolymers.

Other UV blocking additives may be included in the fluoropolymer surface layer. Small particle non-pigmentary zinc oxide and titanium oxide can also be used as UV blocking additives in the fluoropolymer surface layer. Nanoscale particles of zinc oxide and titanium oxide will reflect, or scatter, UV light while being transparent to visible and near-infrared light. These small zinc oxide and titanium oxide particles that can reflect UV light are available, for example, in the size range of 10 nanometers to 100 nanometers from Kobo Products, Inc., South Plainfield, N.J.

Anti-stat additives may also be useful for incorporation into either the fluoropolymer surface layer or into the optical layers to reduce unwanted attraction of dust, dirt, and debris. Ionic salt anti-stats available from 3M Company may be incorporated into PVDF fluoropolymer layers to provide static dissipation. Anti-stat additives for PMMA and CoPMMA (for example, available under the trade designation “STAT-RITE” from Lubrizol Engineered Polymers, Brecksville, Ohio, or under the trade designation “PELESTAT” from Sanyo Chemical Industries, Tokyo, Japan).

In some embodiments, the outer layer 824 includes a polymer of TFE, HFP, and vinylidene fluoride. In some embodiments, the outer layer 824 includes at least one of: a PE, a polyethylene copolymer, a PMMA, an acrylate copolymer, or a polyurethane.

In some embodiments, the first optical layers 834 include a polymer of TFE, HFP, and vinylidene fluoride and the second optical layers 836 include a polyester (such as polyethylene terephthalate (PET)), or vice versa.

The solar mirror element 804 may include at least two different materials. The absorbance spectra of each material alone may not provide high absorbance throughout the absorptive band. Two materials, however, that have complementary absorbance spectra (described herein in more detail) may cooperatively provide the solar mirror element 804 with high absorbance throughout the absorptive band. For example, a first material may have a transmission peak centered at a wavelength in the absorptive band, which may not radiate enough energy in the atmospheric infrared region, but a second material may have a complementary absorption peak centered around the same wavelength in the absorptive band.

A transmission peak may be described as a transmittance greater than 10%, or an absorbance of less than 1. An absorption peak may be described as an absorption of at least 1, or a transmittance of at most 10%. Other transmittance or absorbance values, however, which may be described herein, may be used to define thresholds for transmission and absorption peaks. A transmission peak or absorbance peak may exceed the selected threshold in a bandwidth of at least 10 (in some embodiments, at least 20, 30, 40, 50, 75, or even at least 100) nanometers.

In one example, one of the layers in the solar mirror element 804, such as the outer layer 824 or one of the layers of the reflector 822, may include a first material having a minimum absorbance of less than 1 (a transmission peak) located in a third wavelength range contained in the second wavelength range. A different layer in the solar mirror element 804 may include a second material having a minimum absorbance of at least 1 (an absorption peak) in the third wavelength range. The absorption peak of the second material absorbs light that would otherwise pass through the transmission peak of the first material. In this manner, two or more materials may sufficiently absorb most of the light in the 8 to 13 micrometer absorbance band in a complementary manner.

The metal layer 830 may be disposed on the coolable element 806 or on the bottom of the film 828. In some embodiments, the metal layer 830 is coated onto coolable element 806 or under the film 828. The metal layer 830 may be disposed between coolable element 806 and the film 828. The metal layer 830 may reflect light for at least part of the reflective band. In some embodiments, the metal layer 830 has a high average reflectance in the solar region.

In some embodiments, the optical film 828 or the metal layer 830 alone may not provide high reflectance throughout the reflective band. The metal layer 830 and the film 828 may have complementary reflectance spectra and together may provide the solar mirror element 804 with high reflectance throughout the reflective band. For example, the film 828 may be highly reflective in one range of the reflective band and the metal layer 830 may be highly reflective in another range of the reflective band where the film is not highly reflective.

In some embodiments, the film 828 is highly reflective in a lower wavelength range and the metal layer 830 is highly reflective in a higher wavelength range, which is adjacent to the lower wavelength range. In one example, the film 828 is highly reflective in a range from 0.3 to 0.8 micrometer, and the metal layer 830 is highly reflective in a complementary range from 0.8 to 2.5 micrometers. In other words, the high reflective range of the metal layer 830 begins near where highly reflective range of the film 828 ends. Together, the film 828 and the metal layer 830 may provide high reflectivity in a range from 0.4 to 2.5 micrometers.

Alternatively, or in addition to selecting high absorptivity material, the outer layer 824 or the film 828 may include structures that provide high absorptivity in the atmospheric infrared region, such as inorganic particles. In particular, the structures may be sized appropriately to increase the absorptivity of the solar mirror element 804.

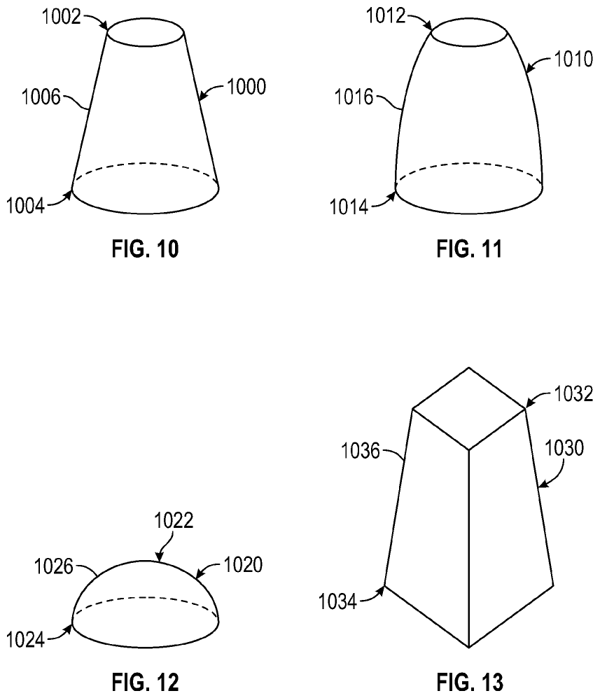

FIG. 9 is a schematic top-down illustration of one example of a surface 900 of an outer layer 924, which may be used as the outer surface 850 of the outer layer 824 of FIG. 8. The surface 900 may also define at least part of the first major surface 114 (FIG. 1) or at least part of the first region 430 of the first major surface 414 (FIG. 4). The outer layer 924 defines a plurality of structures 902, which may be configured to improve absorbance or reflectivity. As illustrated, the plurality of structures 902 are disposed in or on the surface of at least one of the layers, such as the outer layer 924. The structures 902 may be dispersed evenly through at least one of the layers, such as the outer layer 924. In some embodiments, the structures 902 may be disposed in or on the surface and be dispersed evenly through at least one of the layers. The arrangement of the structures 902 may be described as an array, which may be two dimensional or three dimensional. In some embodiments, the structures 902 may be described as microstructures or nanostructures depending on the size of at least one dimension (such as a maximum width or diameter).

The structures 902 may include inorganic particles. For example, each structure 902 depicted may correspond to one inorganic particle. The inorganic particles may be dispersed in or disposed on at least one layer.

The structures 902 may include surface structures. The surface structures may be disposed on a surface, such as the surface 900 of the outer layer 924 or a surface of a film, such as the optical film 828. In some embodiments, the structures 902 may be integrated into or on the surface 900. For example, the structures 902 when formed as surface structures may be formed by extrusion replication or micro-replication on at least one of the layers, as described in U.S. Provisional App. Ser. No. 62/611,639, which is incorporated herein by reference. The surface structures may or may not be formed of the same material as the at least one layer.

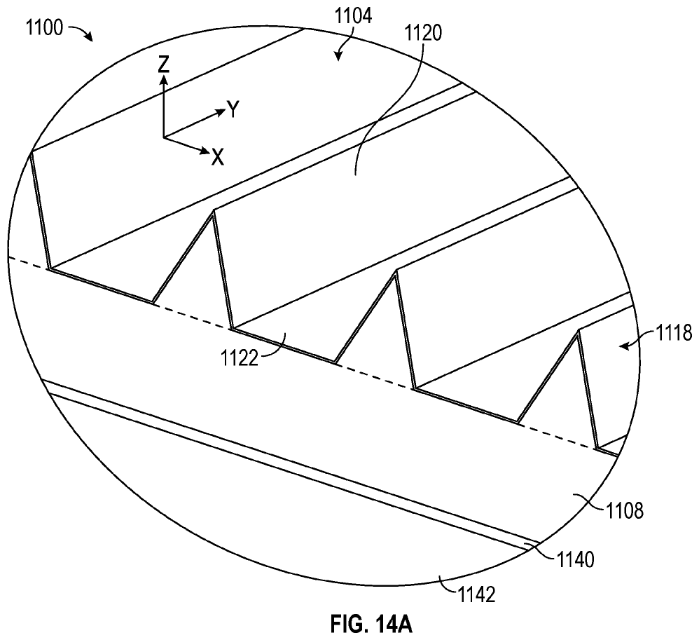

FIGS. 10-13 are schematic illustrations of various examples of surface structures including surface structure 1000, surface structure 1010, surface structure 1020, and surface structure 1030 that define first width 1002, first width 1012, first width 1022, and first width 1032 and second width 1004, second width 1014, second width 1024, and second width 1034, respectively, which may be selected to improve absorbance or reflectivity, which may define at least part of the first major surface 114 (FIG. 1) or at least part of the first region 430 of the first major surface 414 (FIG. 4). The first widths 1002, 1012, 1022, and 1032 may be described as outer widths, and the second widths 1004, 1014, 1024, and 1034 may be described as base widths. In some embodiments, the surface structures 1000, 1010, 1020, 1030 may have an average width in a range of 0.1 to 50 micrometers (for example, between the first widths and the second width), which may facilitate emissivity or absorptivity in the atmospheric infrared region. The surface structures 1010, 1020, 1030, and 1040 may include a sidewall 1006, a sidewall 1016, a sidewall 1026, and a sidewall 1036, respectively, defining the respective first widths 1002, 1012, 1022, and 1032 and second widths 1004, 1014, 1024, and 1034.

The sidewalls 1006, 1016, 1026, and 1036 may be formed in various geometries. Some geometries may be particularly suited to certain manufacturing processes. The geometries may be defined by a cross-section extending between each first width 1002, 1012, 1022, and 1032 and each second width 1004, 1014, 1024, and 1034. The surface structures 1000, 1010, 1020 may be described as conical or having a cone-like shape. As used herein, the term “width” may refer to a diameter of each structure 1000, 1020, 1020, for example, when the cross-section of the structure is circular, oval, or cone-like. In FIG. 10, the cross-section of the sidewall 1006 may include at least one straight line between the widths 1002, 1004. The first width 1002 may be smaller than the second width 1004 to define a slope. In FIGS. 11-12, the cross-section of the sidewalls 1016, 1026 may include at least one curve or arc between the respective first widths 1012, 1022 and second widths 1014, 1024. In FIG. 11, the first width 1012 is non-zero to give a tapered cylindrical shape to the surface structure 1010. In FIG. 12, the first width 1022 is equal to zero to give a hemispherical shape, or half dome shape, to the surface structure 1020. In some embodiments, the surface structure 1020 may be spheroid, or even an ellipsoid shape. As can be seen in FIG. 13, the surface structure 1030 may be described as a square- or rectangular-shaped post. The cross-section of the sidewall 1036 of the surface structure 1030 may include a straight line between the first width 1032 and the second width 1034 as illustrated. In other aspects, the sidewall 1036 may include at least one curve or arc between the widths. The sidewall 1036 may define a slope, wherein the first width 1032 is less than the second width 1034, as illustrated, or may even be vertical, wherein the first and second widths are equal.

Each surface structure 1010, 1020, 1030, and 1040 may protrude from the surface by a height extending orthogonal to the surface. The width of each surface structure 1010, 1020, 1030, and 1040 may be defined orthogonal to the height and parallel to the surface. In some embodiments, each surface structure 1010, 1020, 1030, and 1040 has an average width of greater than or equal to 0.1 micrometer (in some embodiments, greater than or equal to 1, 3, 5, 7, 8, 9, or even at least 10) micrometers. In some embodiments, each surface structure 1010, 1020, 1030, and 1040 has an average width of less than or equal to 50 micrometers (in some embodiments, at less than or equal to 45, 40, 35, 30, 25, 20, 15, 14, 13, 12, 11, 10, 9, or even at most 8 micrometers). In some embodiments, each surface structure 1010, 1020, 1030, and 1040 has an average height of at least 0.5 micrometer (in some embodiments, at least 1, 3, 5, 7, 8, 9, or even at least 10 micrometers). In some embodiments, each surface structure 1010, 1020, 1030, and 1040 has an average height of at most 50 micrometers (in some embodiments, at most 20, 15, 14, 13, 12, 11, 10, 9, or even at most 8 micrometers).

FIGS. 14A-21 show various embodiments related to dirt resistant and antisoiling surfaces, which may define at least part of the first major surface 114 (FIG. 1) or at least part of the first region 430 of the first major surface 414 (FIG. 4). In some embodiments, the outward facing surface of an element, especially a high emissivity element, may define an antisoiling layer. The antisoiling layer may be defined, for example, by an integral or separately outer layer of an element. The antisoiling surface of the antisoiling layer may be disposed opposite a reflector. The antisoiling layer may be textured so as to be microstructured or nanostructured over some or all of its surface; for example, as described in U.S. Provisional Patent Application No. 62/611,636 and in the resulting PCT International Application Publication No. WO 2019/130198, which are incorporated herein by reference. The use of such microstructuring or nanostructuring for the specific purpose of enhancing antisoiling of a cooling film is discussed in U.S. Provisional Patent Application No. 62/855,392, which is incorporated by reference in its entirety herein.

In some embodiments, the nanostructure may be superimposed on the microstructure on the surface of the antisoiling layer. In some such embodiments, the antisoiling layer has an outer major surface (which may be described as an antisoiling surface) that includes micro-structures or nanostructures. The microstructures may be arranged as a series of alternating micro-peaks and micro-spaces. The size and shape of the micro-spaces between micro-peaks may mitigate the adhesion of dirt particles to the micro-peaks. The nanostructures may be arranged as at least one series of nano-peaks disposed on at least the micro-spaces. The micro-peaks may be more durable to environmental effects than the nano-peaks. Because the micro-peaks are spaced only by a micro-space, and the micro-spaces are significantly taller than the nano-peaks, the micro-peaks may serve to protect the nano-peaks on the surface of the micro-spaces from abrasion.

FIGS. 14A, 14B, and 14C are schematic perspective and cross-sectional illustrations of an example of an antisoiling surface structure. In the illustrated embodiment, an antisoiling layer 1108 defining an antisoiling surface 1104 may be coupled to a solar mirror element 1140, which may be used as solar mirror element 104 of FIG. 1. The solar mirror element 1140 may be coupled to a coolable element 1142, which may be used as coolable element 106 of FIG. 1. In some aspects, the antisoiling layer 1108 may be described as being part of the solar mirror element 104.

As illustrated, cross-sections 1100, 1102 of the antisoiling surface structure are shown as antisoiling layer 1108 having antisoiling surface 1104 defined by a series of microstructures 1118. In particular, FIG. 14A shows a perspective view of the cross section 1100 relative to xyz-axes. FIG. 14B shows cross section 1102 in a yz-plane orthogonal to cross section 1102 and orthogonal to axis 1110. FIG. 14C shows cross section 1100 in an xz-plane parallel to axis 1110. Antisoiling surface 1104 is depicted in FIGS. 14A-14C as if antisoiling layer 1108 were lying on a flat horizontal surface. Antisoiling layer 1108, however, may be flexible and may conform to substrates that are not flat.

In some embodiments, microstructures 1118 are formed in antisoiling layer 1108. Microstructures 1118 and remaining portions of antisoiling layer 1108 below the microstructures may be formed of the same material. Antisoiling layer 1108 may be formed of any suitable material capable of defining microstructures 1118, which may at least partially define antisoiling surface 1104. Antisoiling layer 1108 may be transparent to various frequencies of light. In at least one embodiment, antisoiling layer 1108 may be non-transparent, or even opaque, to various frequencies of light. In some embodiments, Antisoiling layer 1108 may include, or be made of, an UV stable material, and/or may include a UV-blocking additive. In some embodiments, antisoiling layer 1108 may include a polymer material such as a fluoropolymer or a polyolefin polymer.

Antisoiling surface 1104 may extend along axis 1110, for example, parallel or substantially parallel to the axis. Plane 1112 may contain axis 1110, for example, parallel or intersecting such that axis 1110 is in plane 1112. Both axis 1110 and plane 1112 may be imaginary constructs used herein to illustrate various features related to antisoiling surface 1104. For example, the intersection of plane 1112 and antisoiling surface 1104 may define line 1114 describing a cross-sectional profile of the surface as shown in FIG. 14C that includes micro-peaks 1120 and micro-spaces 1122 as described herein in more detail. Line 1114 may include at least one straight segment or curved segments.

Line 1114 may at least partially define series of microstructures 1118. microstructures 1118 may be three-dimensional (3D) structures disposed on antisoiling layer 1108, and line 1114 may describe only two dimensions (for example, height and width) of that 3D structure. As can be seen in FIG. 14B, microstructures 1118 may have a length that extends along antisoiling surface 1104 from one side 1130 to another side 1132.

Microstructures 1118 may include a series of alternating micro-peaks 1120 and micro-spaces 1122 along, or in the direction of, axis 1110, which may be defined by, or included in, line 1114. The direction of axis 1110 may coincide with a width dimension. Micro-spaces 1122 may each be disposed between pair of micro-peaks 1120. In other words, plurality of micro-peaks 1120 may be separated from one another by at least one micro-spaces 1122. In at least one embodiment, at least one pair of micro-peaks 1120 may not include micro-space 1122 in-between. Pattern of alternating micro-peaks 1120 and micro-spaces 1122 may be described as a “skipped tooth riblet” (STR). Each of micro-peaks 1120 and micro-spaces 1122 may include at least one straight segment or curved segment.

A slope of line 1114 (for example, rise over run) may be defined relative to the direction of axis 1110 as an x-coordinate (run) and relative to the direction of plane 1112 as a y-axis (rise).

A maximum absolute slope may be defined for at least one portion of line 1114. As used herein, the term “maximum absolute slope” refers to a maximum value selected from the absolute value of the slopes throughout a particular portion of line 1114. For example, the maximum absolute slope of one micro-space 1122 may refer to a maximum value selected from calculating the absolute values of the slopes at every point along line 1114 defining the micro-space.

A line defined the maximum absolute slope of each micro-space 1122 may be used to define an angle relative to axis 1110. In some embodiments, the angle corresponding to the maximum absolute slope may be at most 30 degrees (in some embodiments, at most 25, 20, 15, 10, 5, or even at most 1 degree). In some embodiments, the maximum absolute slope of at least some (in some embodiments, all) of micro-peaks 1120 may be greater than the maximum absolute slope of at least some (in some embodiments, all) of micro-spaces 1122.

In some embodiments, line 1114 may define a boundary between each adjacent micro-peak 1120 and micro-space 1122. The boundary may include at least one of straight segment or curved segment. The boundary may be a point along line 1114. In some embodiments, the boundary may include a bend. The bend may include the intersection of two segments of line 1114. The bend may include a point at which line 1114 changes direction in a locale (for example, a change in slope between two different straight lines). The bend may also include a point at which line 1114 has the sharpest change in direction in a locale (for example, a sharper turn compared to adjacent curved segments). In some embodiments, the boundary may include an inflection point. An inflection point may be a point of a line at which the direction of curvature changes.

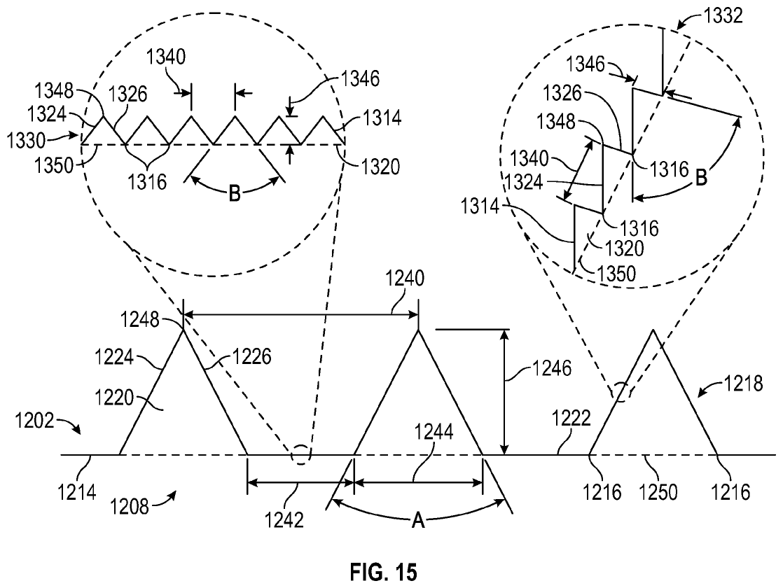

FIG. 15 is a schematic cross-sectional illustration of an example of an antisoiling surface 1202. The antisoiling surface 1202 may be similar to the antisoiling surface 1104, for example, in that microstructures 1118, 1218 of antisoiling layer 1108, 1208 may have the same or similar dimensions and may also form a skipped tooth riblet pattern of alternating micro-peaks 1120, 1220 and micro-spaces 1122, 1222. The antisoiling surface 1202 differs from the antisoiling surface 1104 in that, for example, the antisoiling surface 1202 includes nanostructures 1330, 1332 visible in two magnified overlays in the illustrated embodiment. At least one micro-peak 1220 may include at least one first micro-segment 1224 or at least one second micro-segment 1226. Micro-segments 1224, 1226 may be disposed on opposite sides of apex 1248 of micro-peak 1220. Apex 1248 may be, for example, the highest point or local maxima of line 1214. Each micro-segment 1224, 1226 may include at least one: straight segment or curved segment.

Line 1214 defining first and second micro-segments 1224, 1226 may have a first average slope and a second average slope, respectively. The slopes may be defined relative to baseline 1250 as an x-axis (run), wherein an orthogonal direction is the z-axis (rise).

In some embodiments, the average slope of first micro-segment 1224 may refer to the slope between the endpoints of the first micro-segment. In some embodiments, the average slope of first micro-segment 1224 may refer to an average value calculated from the slopes measured at multiple points along the first micro-segment.

In general, the micro-peak first average slope may be defined as positive and the micro-peak second average slope may be defined as negative. In other words, the first average slope and the second average slope have opposite signs. In some embodiments, the absolute value of the micro-peak first average slope may be equal to the absolute value of the micro-peak second average slope. In some embodiments, the absolute values may be different. In some embodiments, the absolute value of each average slope of micro-segments 1224, 1226 may be greater than the absolute value of the average slope of micro-space 1222.

Angle A of micro-peaks 1220 may be defined between the micro-peak first and second average slopes. In other words, the first and second average slopes may be calculated and then an angle between those calculated lines may be determined. For purposes of illustration, angle A is shown as relating to first and second micro-segments 1224, 1226. In some embodiments, however, when the first and second micro-segments are not straight lines, the angle A may not necessarily be equal to the angle between two micro-segments 1224, 1226.

Angle A may be in a range to provide sufficient antisoiling properties for surface 1202. In some embodiments, angle A may be at most 120 degrees (in some embodiments, at most 110, 100, 95, 90, 85, 80, 75, 70, 65, 60, 55, 50, 45, 40, 35, 30, 25, 20, or even at most 10 degrees). In some embodiments, angle A is at most 85 degrees (in some embodiments, at most 75 degrees). In some embodiments, angle A is, at the low end, at least 30 degrees (in some embodiments, at least 25, 40, 45, or even at least 50 degrees). In some embodiments, angle A is, at the high end, at most 75 degrees (in some embodiments, at most 60, or even at most 55 degrees).

Micro-peaks 1220 may be any suitable shape capable of providing angle A based on the average slopes of micro-segments 1224, 1226. In some embodiments, micro-peaks 1220 are generally formed in the shape of a triangle. In some embodiments, micro-peaks 1220 are not in the shape of a triangle. The shape may be symmetrical across a z-axis intersecting apex 1248. In some embodiments, the shape may be asymmetrical.

Each micro-peak 1220 may define a micro-peak width 1244. The micro-peak width 1244 may be defined by a distance between boundaries 1216 defining the respective micro-peak 1220.

Each micro-space 1222 may define micro-space width 1242. Micro-space width 1242 may be defined as a distance between corresponding boundaries 1216, which may be between adjacent micro-peaks 1220.

A minimum for micro-space width 1242 may be defined in terms of micrometers. In some embodiments, micro-space width 1242 may be at least 10 micrometers (in some embodiments, at least 20, 25, 30, 40, 50, 60, 70, 75, 80, 90, 100, 150, 200, or even at least 250 micrometers). In some applications, micro-space width 1242 is, at the low end, at least 50 micrometers (in some embodiments, at least 60 or 70 micrometers). In some applications, micro-space width 1242 is, at the high end, at most 90 micrometers (in some embodiments, at most 80 or 70 micrometers). In some applications, micro-space width 1242 is 70 micrometers.

As used herein, the term “peak distance” refers to the distance between consecutive peaks, or between the closest pair of peaks, measured at each apex or highest point of the peak.

Micro-space width 1242 may also be defined relative to micro-peak distance 1240. In particular, a minimum for micro-space width 1242 may be defined relative to corresponding micro-peak distance 1240, which may refer to the distance between the closest pair of micro-peaks 1220 surrounding micro-space 1222 measured at each apex 1248 of the micro-peaks. In some embodiments, micro-space width 1242 may be at least 10% (in some embodiments, at least 20, 25, 30, 40, 50, 60, 70, 80, or even at least 90%) of the maximum for micro-peak distance 1240. In some embodiments, the minimum for micro-space width 1242 is, at the low end, at least 30% (in some embodiments, at least 40%) of the maximum for micro-peak distance 1240. In some embodiments, the minimum for micro-space width 1242 is, at the high end, at most 60% (in some embodiments, at most 50%) of the maximum for micro-peak distance 1240. In some embodiments, micro-space width 1242 is 45% of micro-peak distance 1240.

A minimum the micro-peak distance 1240 may be defined in terms of micrometers. In some embodiments, micro-peak distance 1240 may be at least 1 micrometer (in some embodiments, at least 2, 3, 4, 5, 10, 25, 50, 75, 100, 150, 200, 250, or even at least 500 micrometers). In some embodiments, micro-peak distance 1240 is at least 100 micrometers.

A maximum for micro-peak distance 1240 may be defined in terms of micrometers. Micro-peak distance 1240 may be at most 1000 micrometers (in some embodiments, at most 900, 800, 700, 600, 500, 400, 300, 250, 200, 150, 100, or even at most 50 micrometers). In some embodiments, micro-peak distance 1240 is, at the high end, at most 200 micrometers. In some embodiments, micro-peak distance 1240 is, at the low end, at least 100 micrometers. In some embodiments, micro-peak distance 1240 is 150 micrometers.

Each micro-peak 1220 may define micro-peak height 1246. Micro-peak height 1246 may be defined as a distance between baseline 1350 and apex 1248 of micro-peak 1220. A minimum may be defined for micro-peak height 1246 in terms of micrometers. In some embodiments, micro-peak height 1246 may be at least 10 micrometers (in some embodiments, at least 20, 25, 30, 40, 50, 60, 70, 80, 90, 100, 150, 200, or even at least 250 micrometers). In some embodiments, micro-peak height 1246 is at least 60 micrometers (in some embodiments, at least 70 micrometers). In some embodiments, micro-peak height 1246 is 80 micrometers.

Plurality of nanostructures 1330, 1332 may be defined at least partially by line 1214. Plurality of nanostructures 1330 may be disposed on at least one or micro-space 1222. In particular, line 1314 defining nanostructures 1330 may include at least one series of nano-peaks 1320 disposed on at least one micro-space 1222. In some embodiments, at least one series of nano-peaks 1320 of plurality of nanostructures 1332 may also be disposed on at least one micro-peak 1220.

Due to at least their difference in size, microstructures 1218 may be more durable than nanostructures 1330, 1332 in terms of abrasion resistance. In some embodiments, plurality of nanostructures 1332 are disposed only on micro-spaces 1222 or at least not disposed proximate to or adjacent to apex 1248 of micro-peaks 1220.

Each nano-peak 1320 may include at least one of first nano-segment 1324 and second nano-segment 1326. Each nano-peak 1320 may include both nano-segments 1324, 1326. Nano-segments 1324, 1326 may be disposed on opposite sides of apex 1348 of nano-peak 1320.

First and second nano-segments 1324, 1326 may define a first average slope and a second average slope, respectively, which describe line 1314 defining the nano-segment. For nanostructures 1330, 1332, the slope of line 1314 may be defined relative to baseline 1350 as an x-axis (run), wherein an orthogonal direction is the z-axis (rise).

In general, the nano-peak first average slope may be defined as positive and the nano-peak second average slope may be defined as negative, or vice versa. In other words, the first average slope and the second average slope at least have opposite signs. In some embodiments, the absolute value of the nano-peak first average slope may be equal to the absolute value of the nano-peak second average slope (for example, nanostructures 1330). In some embodiments, the absolute values may be different (for example, nanostructures 1332).

Angle B of nano-peaks 1320 may be defined between lines defined by the nano-peak first and second average slopes. Similar to angle A, angle B as shown is for purposes of illustration and may not necessarily equal to any directly measured angle between nano-segments 1324, 1326.

Angle B may be a range to provide sufficient antisoiling properties for surface 1202. In some embodiments, angle B may be at most 120 degrees (in some embodiments, at most 110, 100, 90, 85, 80, 75, 70, 65, 60, 55, 50, 45, 40, 35, 30, 25, 20, or even at most 10 degrees). In some embodiments, angle B is, at the high end, at most 85 degrees (in some embodiments, at most 80, or even at most 75 degrees). In some embodiments, angle B is, at the low end, at least 55 degrees (in some embodiments, at least 60, or even at least 65 degrees). In some embodiments, angle B is 70 degrees.

Angle B may be the same or different for each nano-peak 1320. For example, in some embodiments, angle B for nano-peaks 1320 on micro-peaks 1220 may be different than angle B for nano-peaks 1320 on micro-spaces 1222.

Nano-peaks 1320 may be any suitable shape capable of providing angle B based on lines defined by the average slopes of nano-segments 1324, 1326. In some embodiments, nano-peaks 1320 are generally formed in the shape of a triangle. In at least one embodiment, nano-peaks 1320 are not in the shape of a triangle. The shape may be symmetrical across apex 1348. For example, nano-peaks 1320 of nanostructures 1330 disposed on micro-spaces 1222 may be symmetrical. In at least one embodiment, the shape may be asymmetrical. For example, nano-peaks 1320 of nanostructures 1332 disposed on micro-peaks 1220 may be asymmetrical with one nano-segment 1324 being longer than another nano-segment 1326. In some embodiments, nano-peaks 1320 may be formed with no undercutting.

Each nano-peak 1320 may define nano-peak height 1346. Nano-peak height 1346 may be defined as a distance between baseline 1350 and apex 1348 of nano-peak 1320. A minimum may be defined for nano-peak height 1346 in terms of nanometers. In some embodiments, nano-peak height 1346 may be at least 10 nanometers (in some embodiments, at least 50, 75, 100, 120, 140, 150, 160, 180, 200, 250, or even at least 500 nanometers).

In some embodiments, nano-peak height 1346 is at most 250 nanometers (in some embodiments, at most 200 nanometers), particularly for nanostructures 1330 on micro-spaces 1222. In some embodiments, nano-peak height 1346 is in a range from 100 to 250 nanometers (in some embodiments, 160 to 200 nanometers). In some embodiments, nano-peak height 1346 is 180 nanometers.

In some embodiments, nano-peak height 1346 is at most 160 nanometers (in some embodiments, at most 140 nanometers), particularly for nanostructures 1332 on micro-peaks 1220. In some embodiments, nano-peak height 1346 is in a range from 75 to 160 nanometers (in some embodiments, 100 to 140 nanometers). In some embodiments, nano-peak height 1346 is 120 nanometers.

As used herein, the terms “corresponding micro-peak” or “corresponding micro-peaks” refer to micro-peak 1220 upon which nano-peak 1320 is disposed or, if the nano-peak is disposed on corresponding micro-space 1222, refers to one or both of the closest micro-peaks that surround that micro-space. In other words, micro-peaks 1220 that correspond to micro-space 1222 refer to the micro-peaks in the series of micro-peaks that precede and succeed the micro-space.

Nano-peak height 1346 may also be defined relative to micro-peak height 1246 of corresponding micro-peak 1220. In some embodiments, corresponding micro-peak height 1246 may be at least 10 times (in some embodiments, at least 50, 100, 150, 200, 300, 400, 500, 600, 700, 800, 900, or even at least 1000 times) the nano-peak height 1346. In some embodiments, corresponding micro-peak height 1246 is, at the low end, at least 300 times (in some embodiments, at least 400, 500, or even at least 600 times) the nano-peak height 1346. In some embodiments, corresponding micro-peak height 1246 is, at the high end, at most 900 times (in some embodiments, at most 800, or even at most 700 times) the nano-peak height 1346.

Nano-peak distance 1340 may be defined between nano-peaks 1320. A maximum for nano-peak distance 1340 may be defined. In some embodiments, nano-peak distance 1340 may be at most 1000 nanometers (in some embodiments, at most 750, 700, 600, 500, 400, 300, 250, 200, 150, or even at most 100 nanometers). In some embodiments, nano-peak distance 1340 is at most 400 nanometers (in some embodiments, at most 300 nanometers).

In some embodiments, nano-peak distance 1340 may alternatively or additionally be defined as a distance between corresponding nano-peak boundaries 1316, which may be between adjacent nano-peaks 1320.

A minimum for the nano-peak distance 1340 may be defined. In some embodiments, nano-peak distance 1340 may be at least 1 nanometer (in some embodiments, at least 5, 10, 25, 50, 75, 100, 150, 200, 250, 300, 350, 400, 450, or even at least 500 nanometers). In some embodiments, nano-peak distance 1340 is at least 150 (in some embodiments, at least 200 nanometers).

In some embodiments, the nano-peak distance 1340 is in a range from 150 to 400 nanometers (in some embodiments, 200 to 300 nanometers). In some embodiments, the nano-peak distance 1340 is 250 nanometers.

Nano-peak distance 1340 may be defined relative to the micro-peak distance 1240 between corresponding micro-peaks 1220. In some embodiments, corresponding micro-peak distance 1240 is at least 10 times (in some embodiments, at least 50, 100, 200, 300, 400, 500, 600, 700, 800, 900, or even at least 1000 times) the nano-peak distance 1340. In some embodiments, corresponding micro-peak distance 1240 is, at the low end, at least 200 times (in some embodiments, at least 300) the nano-peak distance 1340. In some embodiments, corresponding micro-peak distance 1240 is, at the high end, at most 500 times (in some embodiments, at most 400 times) the nano-peak distance 1340.

In some embodiments of forming the antisoiling surface, a method may include extruding a hot melt material (for example, a suitable fluoropolymer). The extruded material may be shaped with a micro-replication tool. The micro-replication tool may include a mirror image of a series of microstructures, which may form the series of microstructures on the surface of antisoiling layer. The series of microstructures may include a series of alternating micro-peaks and micro-spaces along an axis. A plurality of nanostructures may be formed on the surface of the layer on at least the micro-spaces. The plurality of nano-peaks may include at least one series of nano-peaks along the axis.

In some embodiments, the plurality nanostructures may be formed by exposing the surface to reactive ion etching. For example, masking elements may be used to define the nano-peaks.

In some embodiments, the plurality of nanostructures may be formed by shaping the extruded material with the micro-replication tool further having an ion-etched diamond. This method may involve providing a diamond tool wherein at least a portion of the tool includes a plurality of tips, wherein the pitch of the tips may be less than 1 micrometer, and cutting a substrate with the diamond tool, wherein the diamond tool may be moved in and out along a direction at a pitch (p1). The diamond tool may have a maximum cutter width (p2) and p₁/p₂≥2.

The nanostructures may be characterized as being embedded within the microstructured surface of the antisoiling layer. Except for the portion of the nanostructure exposed to air, the shape of the nanostructure may generally be defined by the adjacent microstructured material.

A microstructured surface layer including nanostructures can be formed by use of a multi-tipped diamond tool. Diamond Turning Machines (DTM) can be used to generate micro-replication tools for creating antisoiling surface structures including nanostructures as described in U.S. Patent Appl. Publ. No. 2013/0236697 (Walker et al.), which is incorporated herein by reference. A microstructured surface further including nanostructures can be formed by use of a multi-tipped diamond tool, which may have a single radius, wherein the plurality of tips has a pitch of less than 1 micrometer. Such multi-tipped diamond tool may also be referred to as a “nanostructured diamond tool.” Hence, a microstructured surface wherein the microstructures further include nanostructures can be concurrently formed during diamond tooling fabrication of the microstructured tool. Focused ion beam milling processes can be used to form the tips and may also be used to form the valley of the diamond tool. For example, focused ion beam milling can be used to ensure that inner surfaces of the tips meet along a common axis to form a bottom of valley. Focused ion beam milling can be used to form features in the valley, such as concave or convex arc ellipses, parabolas, mathematically defined surface patterns, or random or pseudo-random patterns. A wide variety of other shapes of valley can also be formed. Examples of diamond turning machines and methods for creating discontinuous, or non-uniform, surface structures can include and utilize a fast tool servo (FTS) as described in, for example, PCT Pub. No. WO 00/48037, published Aug. 17, 2000; U.S. Pat. No. 7,350,442 (Ehnes et al.) and U.S. Pat. No. 7,328,638 (Gardiner et al.); and U.S. Patent Pub. No. 2009/0147361 (Gardiner et al.), which are incorporated herein by reference.

In some embodiments, the plurality of nanostructures may be formed by shaping the extruded material, or antisoiling layer, with the micro-replication tool further having a nanostructured granular plating for embossing. Electrodeposition, or more specifically electrochemical deposition, can also be used to generate various surface structures including nanostructures to form a micro-replication tool. The tool may be made using a 2-part electroplating process, wherein a first electroplating procedure may form a first metal layer with a first major surface, and a second electroplating procedure may form a second metal layer on the first metal layer. The second metal layer may have a second major surface with a smaller average roughness than that of the first major surface. The second major surface can function as the structured surface of the tool. A replica of this surface can then be made in a major surface of an optical film to provide light diffusing properties. One example of an electrochemical deposition technique is described in PCT Pub. No. WO 2018/130926 (Derks et al.), which is incorporated herein by reference.

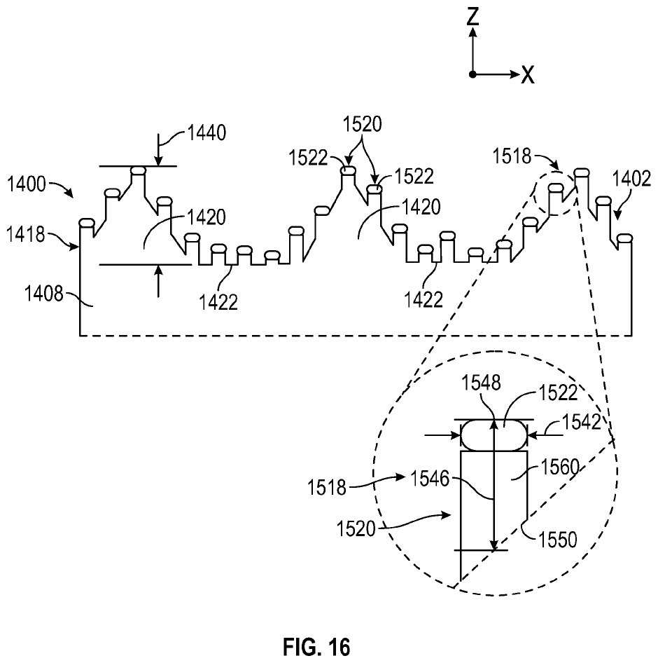

FIG. 16 is a schematic cross-sectional illustration of yet another example of an antisoiling surface usable with the system 100 (FIG. 1). As illustrated, cross section 1400 of antisoiling layer 1408 defines antisoiling surface 1402. The antisoiling surface 1402 may be similar to the antisoiling surface 1202, for example, in that microstructures 1218, 1418 of antisoiling layer 1208, 1408 may have the same or similar dimensions and may also form a skipped tooth riblet pattern of alternating micro-peaks 1220, 1420 and micro-spaces 1222, 1422. Antisoiling surface 1402 differs from surface 1202 in that, for example, nanostructures 1520 may include nanosized masking elements 1522.

Nanostructures 1520 may be formed using masking elements 1522. For example, masking elements 1522 may be used in a subtractive manufacturing process, such as reactive ion etching (RIE), to form nanostructures 1520 of surface 1402 having microstructures 1418. A method of making a nanostructure and nanostructured articles may involve depositing a layer to a major surface of a substrate, such as antisoiling layer 1208, by plasma chemical vapor deposition from a gaseous mixture while substantially simultaneously etching the surface with a reactive species. The method may include providing a substrate, mixing a first gaseous species capable of depositing a layer onto the substrate when formed into a plasma, with a second gaseous species capable of etching the substrate when formed into a plasma, thereby forming a gaseous mixture. The method may include forming the gaseous mixture into a plasma and exposing a surface of the substrate to the plasma, wherein the surface may be etched, and a layer may be deposited on at least a portion of the etched surface substantially simultaneously, thereby forming the nanostructure.

The substrate can be a (co)polymeric material, an inorganic material, an alloy, a solid solution, or a combination thereof. The deposited layer can include the reaction product of plasma chemical vapor deposition using a reactant gas including a compound selected from the group consisting of organosilicon compounds, metal alkyl compounds, metal isopropoxide compounds, metal acetylacetonate compounds, metal halide compounds, and combinations thereof. Nanostructures of high aspect ratio, and optionally with random dimensions in at least one dimension, and even in three orthogonal dimensions, can be prepared.

In some embodiments of a method of antisoiling layer 1408 having a series of microstructures 1418 disposed on antisoiling surface 1402 of the layer may be provided. The series of microstructures 1418 may include a series of alternating micro-peaks 1420 and micro-spaces 1422.

A series of nanosized masking elements 1522 may be disposed on at least micro-spaces 1422. Antisoiling surface 1402 of antisoiling layer 1408 may be exposed to reactive ion etching to form plurality of nanostructures 1518 on the surface of the layer including series of nano-peaks, or nanostructures 1520. Each nano-peak, or nanostructure 1520, may include masking element 1522 and column 1560 of layer material between masking element 1522 and layer 1408.

Masking element 1522 may be formed of any suitable material more resistant to the effects of RIE than the material of antisoiling layer 1408. In some embodiments, masking element 1522 includes an inorganic material. Non-limiting examples of inorganic materials include silica and silicon dioxide. In some embodiments, the masking element 1522 is hydrophilic. Non-limiting examples of hydrophilic materials include silica and silicon dioxide.

Masking elements 1522 may be nanosized. Each masking element 1522 may define maximum diameter 1542. In some embodiments, the maximum diameter of masking element 1522 may be at most 1000 nanometers (in some embodiments, at most 750, 500, 400, 300, 250, 200, 150, or even at most 100 nanometers).

Maximum diameter 1542 of each masking element 1522 may be described relative to micro-peak height 1440 of corresponding micro-peak 1420. In some embodiments, corresponding micro-peak height 1440 is at least 10 times (in some embodiments, at least 25, 50, 100, 200, 250, 300, 400, 500, 750, or even at least 1000 times) maximum diameter 1542 of masking element 1522.

Each nano-peak, or nanostructure 1520, may define height 1546. Height 1546 may be defined between baseline 1550 and the apex 1548 of masking element 1522.

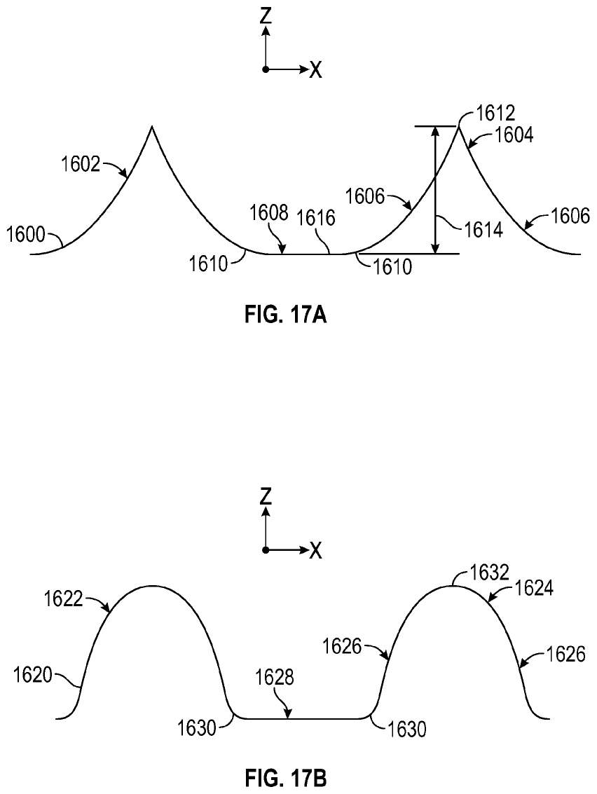

FIGS. 17A-B are schematic cross-sectional illustrations of various examples of surface structures. As illustrated, conceptual lines 1600 and 1620 represent the cross-sectional profile of different forms of peaks 1602, 1622, which may be micro-peaks of microstructures or nano-peaks of nanostructures, for any of the antisoiling surfaces, such as antisoiling surfaces 1104, 1202, 1402. As mentioned, structures do not need to be strictly in the shape of a triangle.

Line 1600 shows that first portion 1604 (top portion) of peak 1602, including apex 1612, may have a generally triangular shape, whereas adjacent side portions 1606 may be curved. In some embodiments, as illustrated, side portions 1606 of peak 1602 may not have a sharper turn as it transitions into space 1608. Boundary 1610 between side portion 1606 of peak 1602 and space 1608 may be defined by a threshold slope of line 1600 as discussed herein, for example, with respect to FIGS. 14A-14C and FIG. 15.

Space 1608 may also be defined in terms of height relative to height 1614 of peak 1602. Height 1614 of peak 1602 may be defined between one of boundaries 1610 and apex 1612. Height of space 1608 may be defined between bottom 1616, or lowest point of space 1608, and one of boundaries 1610. In some embodiments, the height of space 1608 may be at most 40% (in some embodiments, at most 30, 25, 20, 15, 10, 5, 4, 3, or even at most 2%) of height 1614 of peak 1602. In some embodiments, the height of space 1608 is at most 10% (in some embodiments, at most 5, 4, 3, or even at most 2%) of height 1614 of peak 1602.

Line 1620 shows that first portion 1624 (top portion) of peak 1622, including the apex, may have a generally rounded shape without a sharp turn between adjacent side portions 1626. Apex 1632 may be defined as the highest point of the structure of the peak 1622, for example, where the slope changes from positive to negative. Although first portion 1624 (top portion) may be rounded at apex 1632, peak 1622 may still define an angle, such as angle A (see FIG. 15), between first and second average slopes.

Boundary 1630 between side portion 1626 of peak 1622 and space 1628 may be defined, for example, by a sharper turn. Boundary 1630 may also be defined by slope or relative height, as discussed herein.

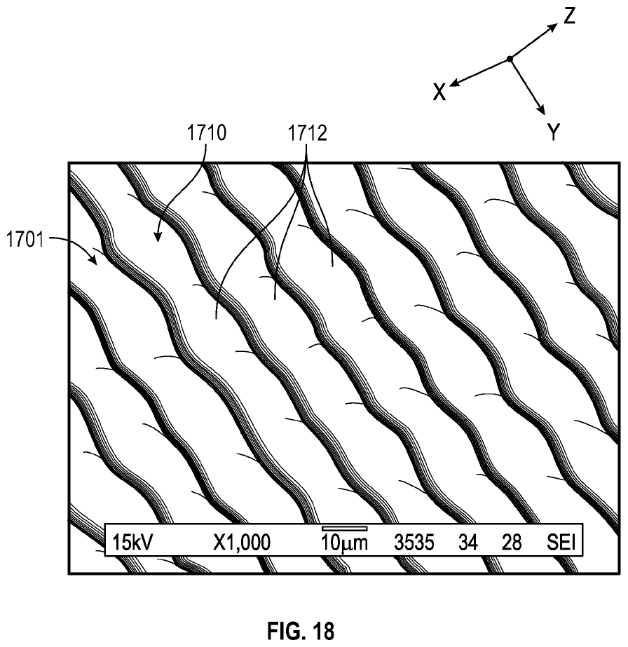

As shown in FIGS. 18 to 21, the antisoiling surface may be discontinuous, intermittent, or non-uniform. For example, the antisoiling surface may also be described as including micro-pyramids with micro-spaces surrounding the micro-pyramids (see FIGS. 18 and 21).

FIG. 18 is a schematic perspective illustration of one example of a further antisoiling surface. As illustrated, first antisoiling surface 1701 is defined at least partially by non-uniform microstructures 1710. For example, if antisoiling surface 1701 were viewed in the yz-plane (similar to FIG. 14B), at least one micro-peak 1712 may have a non-uniform height from the left side to the right side of the view, which can be contrasted to FIG. 14B showing micro-peak 1120 having a uniform height from the left side to the right side of the view. In particular, micro-peaks 1712 defined by the non-uniform microstructures 1710 may be non-uniform in at least one of height or shape. The micro-peaks 1712 are spaced by micro-spaces (not shown in this perspective view), similar to other surfaces described herein, such as micro-space 1122 of antisoiling surface 1104 (FIGS. 14A and 14C).

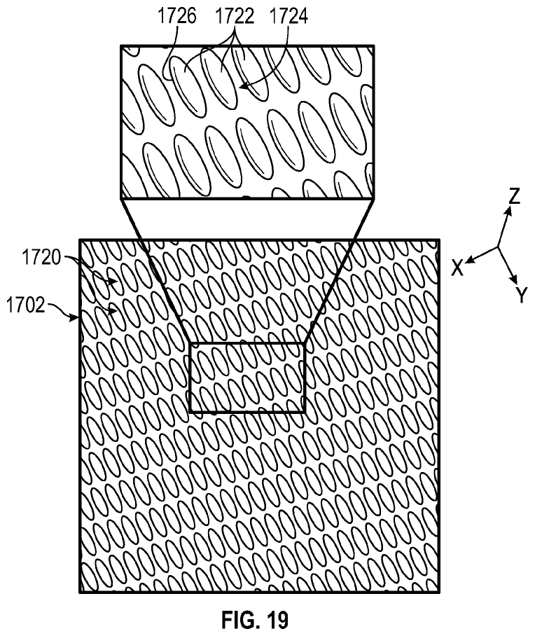

FIG. 19 is a schematic top-down of still another antisoiling surface. As illustrated, second antisoiling surface 1702 has discontinuous microstructures 1720. For example, if second antisoiling surface 1702 were viewed on the yz-plane (similar to FIG. 14B), more than one micro-peak 1722 may be shown spaced by microstructures 1720, which can be contrasted to FIG. 14B showing micro-peak 1120 extending continuously from the left side to the right side of the view. In particular, micro-peaks 1722 of microstructures 1720 may be surrounded by micro-spaces 1724. Micro-peaks 1722 may each have a half dome-like shape. For example, the half dome-like shape may be a hemisphere, a half ovoid, a half-prolate spheroid, or a half-oblate spheroid. Edge 1726 of the base of each micro-peak 1722, extending around each micro-peak, may be a rounded shape (for example, a circle, an oval, or a rounded rectangle). The shape of the micro-peaks 1722 may be uniform, as depicted in the illustrated embodiment, or can be non-uniform.

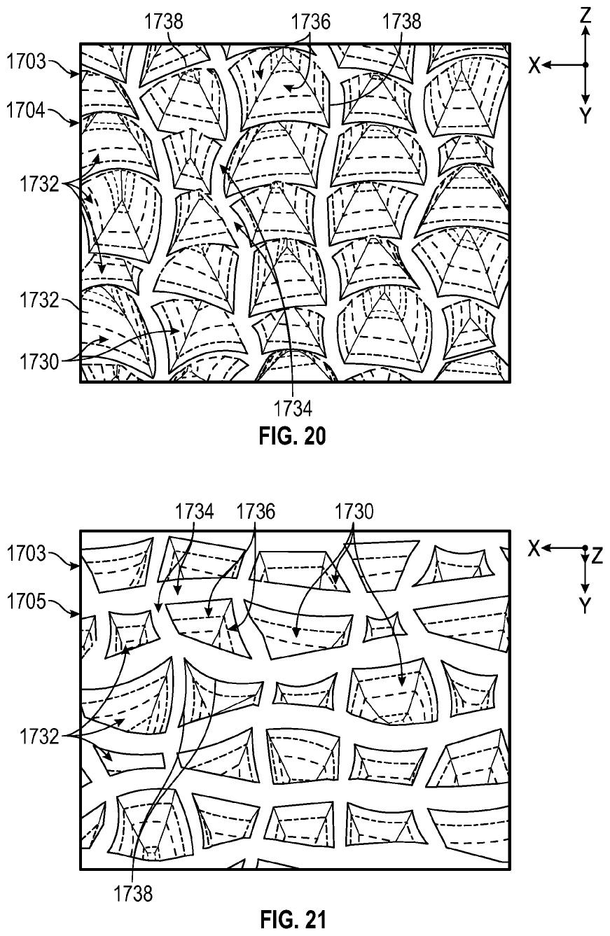

FIGS. 20 and 21 are schematic perspective illustrations of yet another antisoiling surface. First portion 1704 (FIG. 20) and second portion 1705 (FIG. 21) of third antisoiling surface 1703 have discontinuous microstructures 1730. The FIG. 20 view shows more of a “front” side of the microstructures 1730 close to a 45-degree angle, whereas the FIG. 21 view shows some of a “back” side of the microstructures closer to an overhead angle.

Micro-peaks 1732 of microstructures 1730 surrounded by micro-spaces 1734 may have a pyramid-like shape (for example, micro-pyramids). For example, the pyramid-like shape may be a rectangular pyramid or a triangular pyramid. Sides 1736 of the pyramid-like shape may be non-uniform in shape or area, as depicted in the illustrated embodiment, or can be uniform in shape or area. Edges 1738 of the pyramid-like shape may be non-linear, as depicted in the illustrated embodiment, or can be linear. The overall volume of each micro-peak 1732 may be non-uniform, as depicted in the illustrated embodiment, or can be uniform.

The above detailed discussions make it clear that if desired, the antisoiling surface of the antisoiling layer may be textured, for example, microstructured or nanostructured, to enhance its antisoiling properties. In general, the texturing may be achieved in any suitable manner, whether for example, achieved by molding or embossing the surface against an appropriate tooling surface, or by removal of material from an existing surface for example, by reactive ion etching, laser ablation, and so on. In some approaches, the antisoiling layer may include inorganic particles of an appropriate size and/or shape to provide the desired surface texture. In some embodiments, any such particles may be for example, deposited onto surface and adhered thereto. In other embodiments, any such particles may be incorporated (for example, admixed) into the material from which the antisoiling layer is to be formed, with the layer then being formed in a way that allows the presence of the particles within the layer to cause the antisoiling surface to exhibit corresponding texture. In some embodiments the presence of such particles may cause the surface of the antisoiling layer to exhibit texture in the layer as made. In other embodiments, such particles may cause texture to form for example, upon organic polymeric material being removed from the surface of the antisoiling layer (for example, by reactive ion etching) while the inorganic particles remain in place, as noted earlier herein. In a variation of such approaches, an inorganic material may be deposited onto a major surface of the antisoiling layer for example, by plasma deposition, concurrent with an organic material removal (for example, reactive ion etching) process, to achieve similar affects. Such arrangements are discussed in U.S. Pat. No. 10,134,566, which is incorporated herein by reference.

Thus, various techniques of solar energy absorbing and radiative cooling are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A passive cooling article comprising:
a first element defining a first absorbance of greater than or equal to 0.5 in an atmospheric infrared wavelength range from 8 to 13 micrometers and at least partially defining a first average reflectance of greater than or equal to 80% in a solar wavelength range from 0.4 to 2.5 micrometers, the first element comprising a first major surface positioned and shaped to reflect solar energy in the solar wavelength range to an energy absorber spaced a distance from the first major surface; and
a second element defining a thermal conductivity greater than 0.1 W/m-K, the second element thermally coupled to a second major surface of the first element to transfer thermal energy from the second element to the first element to cool the second element.

2. The article according to claim 1, wherein the first element comprises a multi-layer optical film.

3. The article according to claim 2, wherein the first element comprises an ultraviolet reflecting multi-layer optical film.

4. The article according to claim 1, wherein the energy absorber comprises an interior volume to contain a fluid heatable by the solar energy.

5. The article according to claim 1, wherein the energy absorber comprises a photovoltaic cell.

6. The article according to claim 1, wherein the first element is a specular solar mirror in the solar wavelength range.

7. The article according to claim 1, wherein the first major surface has a curved shape.

8. The article according to claim 7, wherein the curved shape comprises a parabolic curve.

9. The article according to claim 7, wherein the curved shape comprises a compound parabolic curve.

10. A passive cooling article comprising:
a first element comprising a first region of a first major surface, the first element defining a first absorbance of greater than or equal to 0.5 in an atmospheric infrared wavelength range from 8 to 13 micrometers and at least partially defining a first average reflectance of greater than or equal to 80% in the solar wavelength range;
a second element defining a thermal conductivity greater than 0.1 W/m-K, the second element thermally coupled to a first region of a second major surface defined by the first element to transfer heat from the second element to the first element to cool the second element; and
an energy absorber comprising a second region of the first major surface configured to receive solar energy in a solar wavelength range from 0.35 to 2.5 micrometers,
wherein the first region of the first major surface is positioned and shaped to direct reflected solar energy in the solar wavelength range to the second region.

11. The article according to claim 10, wherein the energy absorber comprises an interior volume to contain a fluid heatable using the solar energy.

12. The article according to claim 10, wherein the first region of the first major surface comprises a planar shape.

13. The article according to claim 10, wherein the energy absorber comprises a photovoltaic cell.

14. The article according to claim 10, wherein a first vector normal to at least a portion of the first region of the first major surface defines an element angle with a second vector normal to at least a portion of the second region of the first major surface, the element angle being greater than or equal to 90 degrees and less than or equal to 175 degrees.

15. The article according to claim 10, wherein the first element comprises a diffuse solar mirror in the solar wavelength range.

16. The article according to claim 15, wherein the diffuse solar mirror comprises a microporous polymer layer or an array of inorganic particles having an effective D90 particle size of at most 50 micrometers.

17. The article according to claim 10, further comprising a plurality of the first elements and a plurality of the second elements arranged in an alternating array between a first end region and a second end region.

18. The article according to claim 10, wherein the second region of the first major surface comprises a curved shape.

19. A passive cooling system comprising:
an energy absorber configured to receive solar energy in a solar wavelength range from 0.35 to 2.5 micrometers;
a solar mirror element defining a first absorbance of greater than or equal to 0.6 in an atmospheric infrared wavelength range from 8 to 13 micrometers and at least partially defining a first average reflectance of greater than or equal to 80% in the solar wavelength range, the solar mirror element comprising a first major surface shaped to direct reflected solar energy in the solar wavelength range to the energy absorber, and
a coolable element defining a thermal conductivity greater than 0.1 W/m-K, the coolable element thermally coupled to a second major surface of the solar mirror element to transfer heat from the coolable element to the solar mirror element to cool the coolable element.

20. The system according to claim 19, wherein the energy absorber, the coolable element, or both are thermally coupled to an absorption chiller subsystem.

21-25. (canceled)
